(19) United States
(12) Patent Application Publication
(10) Pub. No.: US 2026/0342876 A1
(43) Pub. Date: Oct. 29, 2026

(54) UNIFIED DATA EXCHANGE FOR BI-DIRECTIONAL COMMUNICATION BETWEEN DISTRIBUTED DIGITAL RECORD REPOSITORIES AND SOURCE ENTITIES

(71) Applicant: Oracle International Corporation, Redwood Shores, CA (US)

(72) Inventors: Mykyta Sokolov, Seattle, WA (US); Mikhail Tuchkov, Seattle, WA (US); Stanislav Kondratiev, Seattle, WA (US); Harshit K. Kalley, Belmont, CA (US)

(73) Assignee: Oracle International Corporation, Redwood Shores, CA (US)

(21) Appl. No.: 19/646,772

(22) Filed: Apr. 14, 2026

Related U.S. Application Data
(60) Provisional application No. 63/796,200, filed on Apr. 28, 2025.

(51) Int. Cl. H04L 67/1095; G06F 16/21; G06F 16/25

(52) U.S. Cl. CPC H04L 67/1095; G06F 16/212; G06F 16/258

(57) ABSTRACT

The present disclosure relates to techniques for interoperability between digital record repositories and source entities by leveraging a set of connector modules for seamless communication. A connector module of the set of connector module handles a request from source entity, transforms it by utilizing a data model to make it compatible with a digital record repository and transmit the request to the digital record repository. The connector module, upon detecting a response to the request generated by the digital record repository, performs one or more operations of a set of operations associated with the received response and transmits it to the source entity. The response may correspond to accessing a part or all of missing digital record or a set of digital records, or it may correspond to change in state of digital record repository, or an event associated with the request.

### CROSS-REFERENCE TO RELATED APPLICATIONS

This application claims the benefit of and the priority to U.S. Provisional Patent Application Number 63/796,200, filed on Apr. 28, 2025, which is hereby incorporated by reference in its entirety for all purposes.

### BACKGROUND

With the rise of technological advancements, industries such as finance, healthcare, and education have moved from traditional paper-based records to digital systems, offering greater flexibility, scalability, and ease of management. Electronic records enhance accessibility, allowing users to retrieve data from different locations, while reducing the risk of human error and improving data organization through streamlined tracking and backup systems. These digital solutions also provide enhanced security, including data encryption and restricted access, enabling confidentiality and safeguarding sensitive information. However, the transition to electronic record systems introduces significant challenges, particularly related to interoperability. The integration of diverse systems, each with varying communication protocols and data formats, can create barriers to seamless data exchange, complicating the process of achieving efficient and secure information flow across platforms.

As industries such as healthcare, finance, and education increasingly rely on digital record repositories (DRRs), various services associated with external platforms (or source entities) may depend on these systems to manage and exchange critical data. For example, in healthcare, external platforms offering revenue cycle services, such as patient administration, billing, and health information management, may need to access different electronic health records (EHRs) for a business entity that uses multiple EHR systems. These external platforms often require seamless communication with each EHR for accurate billing, coding, and claims processing. However, each EHR system may have its own communication standards and integration protocols, creating challenges in maintaining consistency across platforms. When a new DRR system is introduced, it may disrupt the established integration methods, requiring custom solutions and increasing operational complexity. Additionally, not all business entities have fully transitioned to a unified cloud infrastructure; some still rely on on-premises systems, which adds complexity to the integration process. This inconsistency makes seamless data exchange more challenging and can impact the scalability and efficiency of the business entity.

### SUMMARY

Some embodiments of the present disclosure relate to techniques employed for interoperability between distributed digital record repositories and source entities by leveraging connector modules for seamless transmission and data reception. A source entity may refer to any service or system—or a set of interconnected services (e.g., a service platform) or systems—that provide specific functionalities or operations, which may include processing, managing, or exchanging data. The source entities across various domains—such as healthcare (e.g., revenue cycle management services, electronic health records), finance (e.g., transaction processing and accounting platforms), and other industries (e.g., educational record systems, customer relationship management platforms)—may require access to digital record repositories for processing and exchanging digital records. The source entities may be internal or external to an organization or a business entity that includes one or more digital record repositories in a distributed manner (e.g., repositories deployed across different departments, facilities, geographic locations, or cloud environments).

A connector module refers to a set of decentralized middleware components between the source entities and a particular digital record repository (DRR). The connector module may be configured to interface with the particular digital record repository (e.g., Millennium) and tailored to comply with the associated schemas, access protocols, and operational requirements of that repository. However, in a multi-DRR environment, the connector module may be customized or instantiated for integration with any digital record repository. In some implementations, a dedicated connector module may be provisioned per digital record repository to facilitate seamless integration with minimal downtime and to reduce processing congestion or data flow bottlenecks across systems.

For interoperability between the one or more digital record repositories and a plurality of source entities, the disclosed techniques may include receiving a request (or a message), directed to the particular DRR of the one or more digital record repositories, from the source entity of the plurality source entities. The request may be received via the connector module that is configured to monitor the associated source entity at predefined intervals of time including a set of schemas, where each schema of the set of schemas is predefined and associated with the corresponding source entity or a corresponding digital record repository of the one or more digital record repositories. The schema defines a structured representation of one or more data entities (e.g., a customer, a product, or a patient), relationships among the data entities (e.g., a patient-doctor relationship), and one or more attributes of the data entities that comprise e.g., field names (e.g., “name”, “dateOfBirth”, “ID”) and data types (e.g., string, date, integer). The request may be generated by the source entity based on a first schema associated with the source entity. Upon receiving, the connector module may validate the request based on the first schema associated with the source entity to maintain consistency across different data types of the data entities.

The validated request may be transformed by the connector module by utilizing a second schema of the set of schemas associated with the particular DRR. The transformed request may be transmitted to the particular digital record repository that may receive the request via an application program interface (API). The particular DRR may generate a response based on the transmitted request. For example, if the request corresponds to a backfill request—such as one initiated during onboarding of a new source entity (e.g., a system, application, or data provider), or triggered to synchronize missing digital records from a specific historical time point—the response may correspond to a bulk response. In such cases, a large set of digital records associated with the specified time range or data gap may be retrieved and returned in a structured format. Similarly, if the request corresponds to an on-demand retrieval request—typically initiated by a user, application, or service (associated with the source entity) to access a set of specific digital records in real time—the response may correspond to the bulk response involving the retrieval of a significant volume of data. For instance, the on-demand request may comprise, "all transaction logs for a given account over the past year".

For generating the bulk response, the DRR may trigger one or more operations of a set of operations, for example, the DRR may retrieve relevant digital records based on the backfill request from an associated database. The DRR may then generate a payload comprising the relevant digital records in a structured form based on the second schema. In some examples, the DRR may further process the payload based on the compliance with standards in place such as HIPPA, FHIR, ICD-10 or GDPR. For example, the processing may include cleaning the relevant digital records to filter out any duplication or re-querying any missing digital record of the relevant digital records. Alternatively, or additionally, the relevant digital records may be de-identified by masking personal identification information associated with the relevant digital records.

In some instances, once the payload has been processed (converting the payload into a standardized format), the payload (or the generated response) may undergo batching for grouping multiple responses—such as bulk responses from backfill requests or multiple discrete on-demand requests—into a single transmission. The batching may provide efficiency by reducing overhead of dealing with data items individually, thereby enhancing resource utilization in data processing, streaming and workflow automation systems. The generated bulk response may be stored or uploaded (e.g., as objects or files) into a file storage system associated with the particular DRR. The generated bulk response is typically large or complex to handle efficiently via real-time API calls alone. Therefore, the generated bulk response may be offloaded to an object storage associated with the connector module. The connector module may be configured to monitor the particular digital record repository continuously or at predefined intervals of times.

In some aspects, when the connector module detects the generated bulk response (or a new object) in the file storage system of the particular DRR, as a result of the monitoring, it may trigger a series of processes (or jobs) for exporting the new object to an object storage of the connector module. For example, the connector module may initiate a first event (e.g., export_object) including metadata (e.g., reference data such as a request identifier (ID), a namespace, and a reference ID of the object location) indicating that the new object is detected. It may then initiate a copying job. In some examples, the connector module may perform a data encryption job during the copy job, applying same encryption key used for encryption of the event stream (e.g., a shared symmetric key or tenant-specific key used for both event stream transport and object data encryption reducing key management overhead). The connector module may log, or record metadata (e.g., a job identifier and status of the job) associated with the copy job and may also monitor the progress of the copy job. If the copy job fails, the connector module may retry by returning back to the data encryption job. If the retry also fails, the connector module may generate a notification or a second event (e.g., “export_failed”) and abandon the copy job. On successful completion, the second event may be emitted that may notify a completion of the copy job (e.g., “export_object_complete”) with the same metadata, informing other components of the connector module regarding readiness of the new object without performing a fresh look up. Finally, the new object may be moved to the object storage, where it may no longer be monitored by the connector module but retained in accordance with a retention policy.

After export jobs of the new object are completed and the particular DRR generates a signal indicating a completion marker (e.g., an export_complete), the connector module may detect this signal and confirm that no other (new) objects remain in the export location (e.g., the file storage system). The connector module may then emit a third event (e.g., export_complete) to the system stream. Subsequently, a notification may be generated to the source entity via the system stream associated with the connector module indicating an availability of the generated response in the object storage corresponding to the backfill request or on-demand retrieval request.

In some aspects of the present disclosure, when the request comprises a write-back request from the source entity that corresponds to an update to one or more digital records associated with the particular DRR, the generated response may correspond to an event response. The write-back request may comprise one or more digital records to be written or updated in the particular DRR. The DRR, on receiving this request (e.g., via the API), may update the one or more digital records and generate an event response that corresponds to the outcome of the write operation. For example, the event response may indicate a successful update, partial success with validation errors, or a failure due to constraints such as schema mismatches, permission issues, or data integrity violations. In some examples, the event response may also include metadata such as timestamps, record identifiers, versioning information, or audit logs for downstream processing or monitoring. The event response may be received via an event stream associated with the connector module that may validate the event response, on receiving, based on the second schema associated with the particular DRR. Once the validation is completed, the event response may be forwarded or transmitted to the source entity via the

In some instances, for execution of the requests (or events) in an ordered manner, the connector module may store a status of the request, and a set of jobs associated with it. Additionally, the connector module may implement a fan-out mechanism, where the generated response may be broadcasted or routed to multiple source entities or downstream systems. In some examples, the source entity may generate a request that is directed to multiple digital record repositories. For the particular example, the fan-out mechanism may support routing the request from the source entity to multiple digital record repositories. The fan-out mechanism may facilitate coordinated scheduling, notification, or triggering of follow-up actions across the participating systems, based on the status or content of the write-back operation.

In some aspects of the present disclosure, the connector module may be configured to provide change event streaming via the event stream, where updates such as new records, modifications, or deletions are streamed in real time from the particular DRR to the source entities.

In some embodiments, a system is provided that includes one or more data processors and a non-transitory computer readable storage medium containing instruction which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 illustrates an exemplary architecture configured to facilitate unified, bidirectional communication between multiple different digital record repositories (DRRs) and one or more source entities through multiple connector modules.

FIG. 2 illustrates an exemplary architecture of a set of middleware components within a connector module, enabling secure, bi-directional communication between a digital record repository and the one or more source entities in accordance with some aspects of the present disclosure.

FIG. 3 shows an illustrative architecture of the connector module for processing messages from the digital record repository in accordance with some aspects of the present disclosure.

FIG. 4A illustrates an exemplary architecture for managing and facilitating data exchange (or the messages) between the digital record repository and a source entity (or a service platform) using the connector module in accordance with some aspects of the present disclosure.

FIG. 4B shows an exemplary architecture for directing the messages from the source entity to the digital record repository.

FIG. 5 shows an exemplary sequence diagram illustrating an exchange of the messages between the connector module and the source entity to perform a backfill operation.

FIG. 6 shows an exemplary layered stack employed within the connector module for transmission and reception of the messages.

FIG. 7 shows an exemplary flow chart for the unified, bidirectional communication between the multiple different digital record repositories and the one or more source entities through the multiple connector modules.

FIG. 8 depicts a simplified diagram of a distributed system for implementing an embodiment of the present disclosure.

FIG. 9 is a simplified block diagram of a cloud system environment in accordance with certain aspects of various embodiments of the invention.

FIG. 10 illustrates an exemplary computer system that may be used to implement certain aspects of the present disclosure.

### DETAILED DESCRIPTION

The present disclosure relates to techniques for enabling interoperability between distributed digital record repositories (DRRs) and a plurality of source entities by leveraging connector modules. The disclosed techniques may facilitate seamless transmission, transformation, validation, and reception of digital records across decentralized systems or entities. The connector modules may serve as intermediary middleware components, enabling structured data (or message) exchange and integration between disparate digital record repositories and the source entities (e.g., including diverse services). These connector modules may enable minimal downtime, maintain schema conformity, and support data standardization, thus enhancing efficiency and scalability in environments involving multiple repositories and data consumers.

The digital record repositories (DRRs) may refer to structured or semi-structured data storage systems used to maintain domain-specific records within an organization (or a business entity) or across multiple organizations. These DRRs may be deployed in a distributed manner and vary significantly in terms of data schemas, storage formats, access protocols, and deployment models, including cloud-based, on-premises, or hybrid configurations. DRRs may include, but are not limited to, electronic health record (EHR) systems in the healthcare industry, transaction ledgers or regulatory databases in finance, learning management systems and student information repositories in education, and customer interaction logs or sales databases in enterprise platforms. A source entity may refer to any platform, system, or application—or a collection of interoperable components—accessing one or more DRRs to perform operations such as data analysis, real-time decision-making, historical audits, or transactional updates. These source entities may be internal (e.g., business units or departmental systems) or external (e.g., third-party services or partner platforms) to the business entity incorporating the DRRs.

To enable scalable and reliable interoperability between the source entities and diverse DRRs, the present disclosure incorporates connector modules that offer a decentralized solution, serving as intermediary middleware layers. Each connector module may be instantiated or configured for a specific DRR and is responsible for validating, transforming, and routing data between the DRR and its associated source entities. These modules are capable of abstracting the complexity inherent in direct message exchanges—such as protocol differences, schema mismatches, and varied authentication flows—between DRRs and source entities. By offering a digital record repository–agnostic approach, the connector modules simplify and accelerate integration efforts. The disclosed connector modules may support data operations including backfill, real-time event change streaming, write-back updates, and on-demand retrievals. Across domains, whether in healthcare (e.g., clinical data sync), finance (e.g., audit log reconciliation), or education (e.g., performance data export). The connector module may enable the source entities to interact with DRRs using a consistent interface, regardless of the underlying repository type, protocol, or deployment. This enables a loosely coupled, scalable integration framework that hides infrastructure complexity while ensuring data fidelity, security, and operational efficiency.

Instead of having one central system that handles every operation (e.g., transforming data or converting communication protocols for each service), these tasks are pushed to the individual systems that need them (such as the RevCycle service or EHR system). This makes the system more efficient, flexible, and scalable by ensuring that each component only manages its own specific tasks without overwhelming a central service with unnecessary complexity.

In some aspects of the present disclosure, the disclosed techniques include receiving requests or messages from one or more source entities directed to a particular digital record repository (DRR) via a connector module. These requests may correspond to various operations, such as data retrieval, historical backfill, write-back, or change event subscription. The connector module may be configured to monitor the source entity or the associated communication channels at predefined intervals or in real time and may validate each received request based on a predefined first schema associated with the source entity. A schema defines a structured representation of data entities, their relationships, and attributes, thereby providing compliance of the incoming message or request with the expected data structure and data type integrity. As used herein, the term “message” may refer to any form of data exchange between a digital record repository (DRR) and a source entity, including but not limited to a request, a response, or any other communication that facilitates the transmission or reception of digital records or associated metadata.

Upon successful validation, the connector module may transform the request or the message using a second schema associated with the target DRR. The transformation process may involve data mapping, field renaming, type conversion, and structural alignment, enabling compatibility with the data model (or schema) of the DRR and communication protocol. The transformed request may then be transmitted to the DRR through an application programming interface (API). Depending on the nature of the request, the DRR may perform various internal operations to fulfill the request, such as querying an internal database, generating a structured response payload, and applying compliance-related processing—such as de-identification, deduplication, or format normalization in accordance with applicable standards such as HIPAA, GDPR, or industry-specific taxonomies.

In response to a backfill request—such as one initiated during the onboarding of a new source entity or the synchronization of historical data—the DRR may retrieve a large volume of digital records corresponding to the requested time period or data gap. These records may be packaged into a bulk response that is structured according to the second schema associated with the DRR. In other cases, an on-demand retrieval request, such as a service requesting transaction logs for a given entity or user over a specified duration, may also result in a bulk response depending on the scope of data involved. The DRR may then transmit the response to the connector module, where it may be optionally processed, batched, or offloaded to a file storage system (FSS) or object storage for further handling.

To improve performance and enable efficient data transfer, the connector module may implement batching mechanisms that consolidate multiple responses—such as from sequential backfill jobs or multiple discrete on-demand requests—into a single, structured transmission. When the generated response payload is too large or complex for real-time API transport, the response may be uploaded as one or more objects to the file storage system of the DRR. The connector module, which may be configured to continuously or periodically monitor this storage, may detect presence of new objects and initiate export jobs that may involve encryption, metadata logging, and object transfer to its own object storage. The connector module may initiate these export processes using event-driven workflows. For example, upon detecting a new object, the connector module may emit a first event indicating that a new export operation has started. During a copy process for copying the new object from FSS to object storage, encryption may be applied using a shared symmetric key or a tenant-specific key to maintain consistency and reduce key management overhead. If the export job fails, the connector module may attempt retrying and emit a failure event upon exhaustion of retry attempts. On a successful export, a second event may be emitted, signaling a readiness of the new object for downstream consumption by the source entities or other system components. A final completion signal from the DRR may trigger the connector module to verify that all exports have concluded, after which a third event may be published to confirm the completion of the process and notify the relevant source entities.

In the case of a write-back request—where the source entity sends updated or new digital records to be written into the DRR, the connector module may validate the request and forward it to the appropriate DRR endpoint. Upon processing, the DRR may return an event response indicating the result of the write operation (e.g., success, partial success, failure), including metadata such as timestamps, record identifiers, versioning information, and error descriptions if applicable. The connector module may then validate this response against the expected schema and distribute it back to the originating source entity or fan out the event response to multiple subscribed systems for further processing, coordination, or monitoring.

To enable orderly processing and traceability, the connector module may maintain a persistent state for each request and track the status of associated jobs. It may also implement a fan-out mechanism to distribute event responses or trigger operations across multiple downstream systems or DRRs. This supports use cases where a single request must be routed to multiple DRRs or where multiple systems require notification of the same data event, thereby facilitating scalable, loosely coupled data exchange and orchestration across a multi-DRR, multi-source environment.

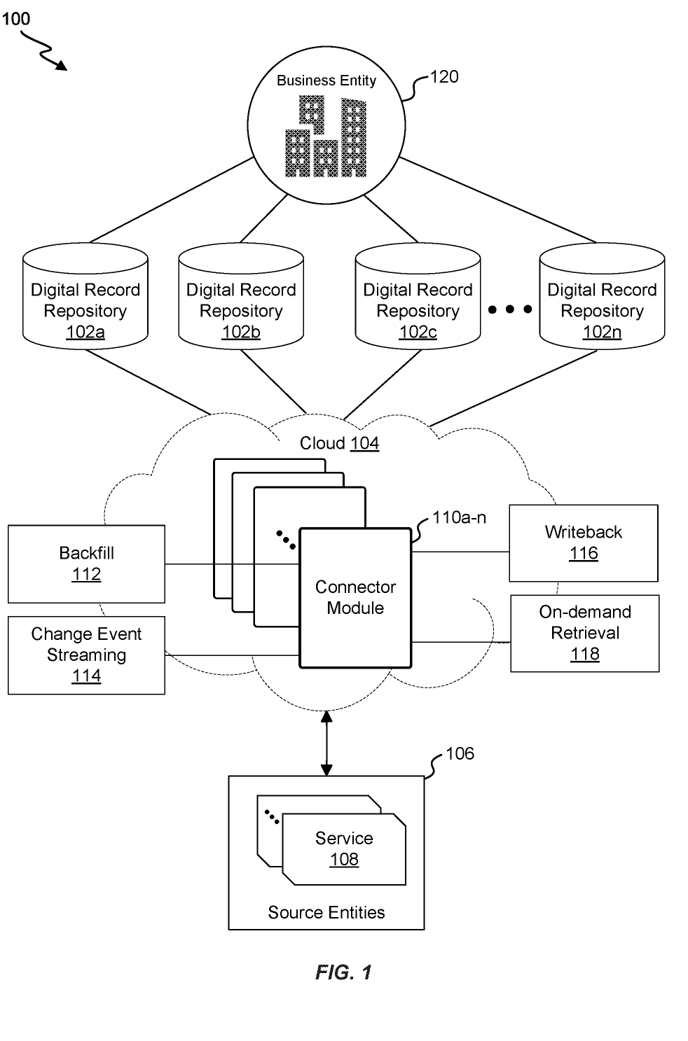

FIG. 1 illustrates an exemplary architecture 100 configured to facilitate unified, bidirectional communication between multiple different digital record repositories (DRRs) 102a–n and one or more source entities through multiple intermediary connector modules 110a–n. DRRs may represent various structured or semi-structured digital storage systems across industries, including but not limited to electronic health records (EHRs) in healthcare, transaction ledgers in finance, and student information systems in education. Each DRR 102 may follow distinct schemas, communication protocols, or deployment models (e.g., cloud-based, on-premises, or hybrid). A source entity 106 may refer to any service, platform, or system—or a set of interconnected services e.g., 108a-m, systems or components that provide specific functionalities or operations, which may include processing, managing, or exchanging data. The source entity may be internal or external to an organization or a business entity 120 that includes multiple different digital record repositories 102a-n.

To enable seamless and scalable integration, the disclosed techniques may include connector modules 110a-n, each corresponding to a specific DRR. The connector modules 110 may comprise a set of middleware components to validate schemas of received requests, perform conversion to make the received requests compatible with the digital record repositories 102a-n and share the converted (or transformed) requests to the digital record repositories 102a-n. Moreover, the connector modules 110a-n may handle responses from the digital record repositories 102a-n and share these responses to the corresponding source entities 106. Additionally, to execute an operation related to a request from a source entity, the connector module 110 may utilize a dataflow pipeline in pre-defined order to perform operations such as: (i) backfill 112, where historical data is exported from the DRR and delivered in batches to the source entity via an object storage; (ii) change event streaming 114, where updates such as new records, modifications, or deletions are streamed in real time from DRRs 102a-n to the source entity; (iii) writeback 116, where the service platform write data (e.g., demographic updates or outcomes) back to the originating DRRs 102a-n; and (iv) on-demand retrieval, where the source entity requests additional data elements in response to incomplete event payloads or specific operational needs.

The connector module 110a-n may be configured to be deployment-agnostic such that it can operate seamlessly in cloud-based, on-premises, or hybrid environments depending on the infrastructure of the digital record repositories (DRRs) and the service platforms accessing the DRRs. In scenarios, where DRRs are hosted in legacy on-premises systems—common in industries such as healthcare or finance, the connector modules 110a-n can be co-located within the same network to reduce latency and maintain local compliance. Alternatively, for cloud-native or hybrid environments, the connector modules 110a-n can be deployed in the cloud 104 and securely interact with DRRs 102a-n using virtual private network (VPN) tunnels, secure APIs, or federated identity mechanisms. The object storage layer used for backfill export and the event streaming pipeline can also reside in cloud 104, making it possible to centralize data synchronization logic while accommodating DRRs 102a-n that remain distributed. This flexibility enables the organizations or business entities undergoing cloud transitions to integrate external services without overhauling their infrastructure, preserving investments in existing systems while enabling modern interoperability patterns.

Centralization in the system (e.g., in cloud-based environment) may come with a downside to providing better resources such as computational power, high throughput and storage and tackling such issues. The connector module 110a-n focuses on an agnostic approach for services 108a-m running on the source entities 106 to communicate with the digital record repositories 102a-n. In doing so, it offloads functions from services 108a-m running on the source entity thereby preventing the source entity (e.g., customer-relationship services) from overloading. Moreover, the connector module 110a-n may facilitate the service discovery along with providing guidelines for secure communication for both in cloud and on-premises systems.

This architecture addresses a common challenge in industries increasingly dependent on distributed digital systems, namely, the lack of standardized integration pathways among DRRs and external services. For example, in healthcare, a revenue cycle platform may require access to disparate EHR systems for patient billing and health information management; in finance, a fraud detection service may require unified access to multiple transaction ledgers maintained across different platforms. The connector modules abstract away system-specific protocols, enabling source entities to interface with multiple DRRs through a unified communication layer. This reduces the need for repetitive custom integrations, ensures data consistency across systems, and supports multitenancy, allowing organizations to scale their services efficiently across diverse record environments.

The disclosed techniques may offer several advantages in addressing the persistent challenge of fragmented and non-standardized communication across digital record systems. By abstracting the complexity of integration into modular connector components, the disclosed techniques enable service platforms to seamlessly interact with multiple DRRs regardless of their underlying data models, hosting environments, or vendor-specific APIs. This reduces the need for custom integrations each time a new DRR is introduced or replaced, thus lowering operational costs and development effort. Moreover, the inclusion of mechanisms for bulk backfill, real-time change event streaming, writeback, and on-demand retrieval enables that data exchanges remain accurate, complete, and responsive to service needs. The system may support multitenancy, providing scalable deployment across diverse organizational hierarchies, and facilitates auditability and compliance by centralizing exchange logic. As a result, business entities can maintain operational continuity, improve data reliability, and achieve greater agility in responding to market or regulatory demands.

To address the compliance and security concerns, the connector module 110 may follow one or more security standards, associated with inter-system communication (a system herein refers to a standalone data entity such as digital record repository 102 or source entity), to transform request from one end to make it compatible with the other. The disclosed techniques may include framework such as IAM (identity and access management) that encompasses practices to manage the authenticity and access control for the source entities 106. Additionally, it may include OAuth, a standard that allows the service to access digital records without sharing the credentials by using the access token wherein the access token indicates the range of access and particular service details thereby offering restricted access to distinct subject record in digital records. Thus, the connector module 110 can offer both authentications, verifying the identity of the service or a user accessing the digital records, and authorization, the range of access to a particular service or user, processes for the integrated digital record repositories 102a-n.

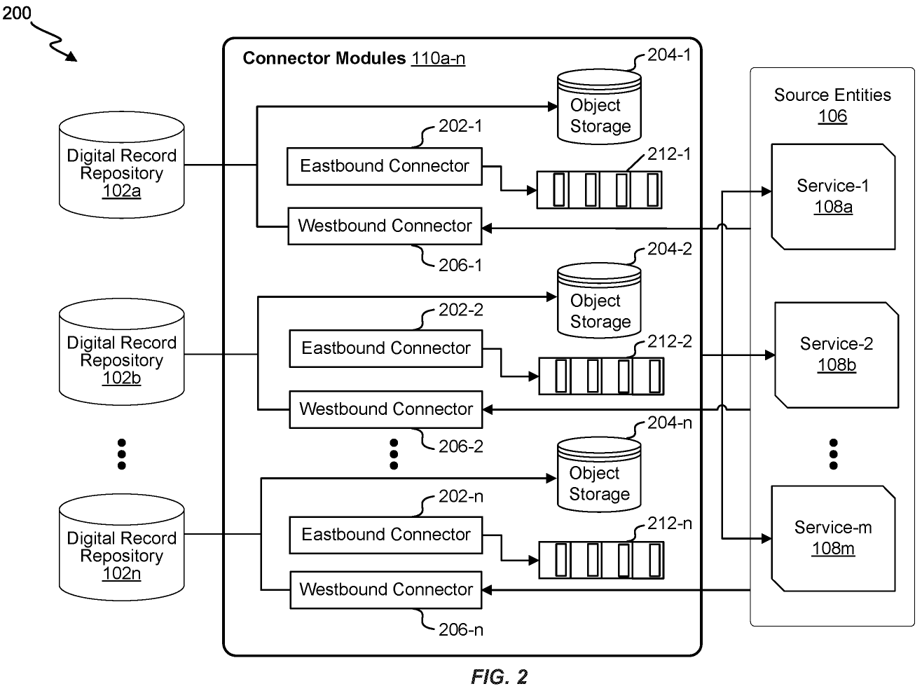

FIG. 2 illustrates an exemplary architecture 200 of a set of middleware components within each connector module, enabling secure, bi-directional communication between digital record repositories 102a-n and source entities. The exemplary architecture 200 is designed to be domain-agnostic, making it applicable across various industries such as healthcare, finance, and inventory management. For instance, in healthcare, the disclosed techniques may facilitate seamless data exchange between electronic health records (EHR) and revenue cycle management services comprising components e.g., health information management (HIM), PAS (patient administration system) and the like. Similarly, in finance, it can enable communication between financial databases and transaction processing systems. Each digital record repository 102a-n has a dedicated connector module 110 encapsulating the logic and components necessary to exchange, translate and synchronize data in both directions.

The connector module 110 is a logical unit that enables bi-directional data exchange between the digital record repository and the source entity. The connector module 110 is aimed at performing appropriate formatting, transmission and storage and synchronization of data across both systems. Each connector module comprises various subcomponents: (1) an Eastbound connector 202 configured to transmit data from the DRR toward the source entity; (2) a Westbound connector 206 for propagating updates or writebacks from the source entity to the DRRs 102a-n; (3) an event stream interface 212 that supports real-time data synchronization for change events; and (4) a shared object storage 204 used primarily for storing bulk-exported backfill data batches. The Eastbound connectors 2021, ..., 202n may support REST APIs (application programming interface) for real-time and on-demand retrieval requests, bulk export APIs for scheduled or batch data transfers, and streaming APIs for real-time synchronization e.g., Kafka, Webhooks. The Eastbound connector 202, also serving as an event listener (or event bus) for DRRs, may be responsible for extracting and mapping structured records (e.g., registration, lab results), triggering events based on repository state changes, and enabling data normalization and schema translation.

The Westbound connector 206 of the connector module 110 sends messages from the source entity back to the digital record repository for updating master data (e.g., new entries, demographics), and back-porting derived or enriched data from the source entity. The Westbound connector 206 may leverage API endpoints of the repository, custom handlers or database adapters. The object storage 204 may temporarily or persistently hold data objects in transit, serving as a buffer for asynchronous processing, a checkpoint for reliability and fault tolerance, and staging area for bulk or partial transformation. The event stream interface 212 manages real-time or near-real-time event flow or data flow (e.g., by leveraging stream API), subscribing to events or changes from the repository (e.g., new registration, or updated records) by the event bus, publishing or relaying events to the source entity or processing pipelines, and enabling reactive, event-driven architecture.

When a source entity such as a service platform or external system needs to backfill data from a digital record repository (DRR), it sends a data request specifying the missing data or historical information it needs. Backfill refers to the process of retrieving missing or incomplete data that was not captured or synchronized during initial data exchanges. This typically occurs during onboarding or when historical data is required but was previously omitted or delayed due to system constraints or integration challenges. The backfill process enables capturing and updating of all relevant data, whether historical or current, for enabling comprehensive and accurate records for continued operations. These requests are generally part of a broader synchronization or onboarding process so that all relevant data types, such as subject records, financial transactions, or inventory data, are included.

Upon receiving the backfill request, the connector module 110 (or any middleware) processes it and extracts the requested data from the DRR. The data is then stored in a designated location (e.g., object storage 204) and the source entity is notified through a notification stream (e.g., 212) indicating the availability of the backfilled data. Similarly, state change events are transferred to the source entity (such as a RevCycle service) through a continuous data pipeline (e.g., event stream 212) established between the DRR 102 and the source entity. When a state change occurs in the DRR, such as a subject record update, a new transaction, or a clinical event, the DRR triggers an event indicating that data has changed. Typically, the DRR system continuously sends state change events to the connector endpoint, which processes and normalizes the data. The connector then forwards these change events to the source entity (e.g., RevCycle services) via an event stream, ensuring real-time data synchronization. The communication protocol for sending these events may vary depending on the specific DRR system or source entity involved. Once the state change event is received, the source entity processes the updated data, integrating it into its system for further action, such as billing, claims management, or other revenue cycle tasks.

As mentioned earlier, each connector module 110 is specialized to interact with a specific DRR, allowing the source entity to manage communication with multiple DRRs simultaneously. These connector modules handle the differences in data formats, protocols, and integration methods required by each DRR. The connector modules support multitenancy such that a single instance of the connector module 110 can serve multiple business entities or clients, each with their own DRRs and corresponding source entities or services, whether internal or external. The data and configurations associated with each business entity are kept isolated, allowing multiple clients to use the same infrastructure without affecting each other’s data. This approach enables different business entities to interact with their respective DRRs and services through a shared set of connector modules, reducing the need for separate instances for each entity. Despite sharing the same infrastructure, data of each business entity is securely managed and separated to avoid data leakage or cross-contamination. The connector modules 110 provide a scalable, efficient way to integrate diverse systems while maintaining data integrity and isolation across multiple tenants.

The Westbound connectors 206-1,206-2…206-n possess the functionality to receive requests or messages from the source entity (or service), verify and transfer a transformed request to DRRs 102. The Westbound connectors may serve as an event listener to the source entity. The Westbound connectors 206, upon the call of these services, may run a logic dedicated to a type of request or message. The connector module 110, in addition to Eastbound connectors 202, event streams and storage, incorporate a set of APIs for different types of requests or messages handling between the source entity and the Westbound connectors 206. For example, to handle the on-demand data retrieval, an API suitable for handling multiple concurrent requests with platform independence may fit well. The REST APIs can provide these along with a room for security features such as OAuth, API keys and compatibility with web-based protocols thereby making them suitable for operation such as on-demand data retrieval.

To transfer backfill or bulk export data from the connector module 110 to the source entity, it may require APIs such that it offers compatibility with web-based protocol including HTTP and MQTT likewise the REST API. Moreover, such APIs may be capable of transferring a huge volume of data with little to no data loss. Another additional feature of such API may include the low latency and subsequent call for data transfer. To cater for such demands, the Westbound connectors 206 may use the bulk export API where the object inside the object storage 204 may transfer efficiently. The Eastbound connectors 202 also include the streaming API (e.g., event stream 212), an API designed for real time data synchronization. Thus, the variance in form of APIs offers convenience in the exchange of different types of messages.

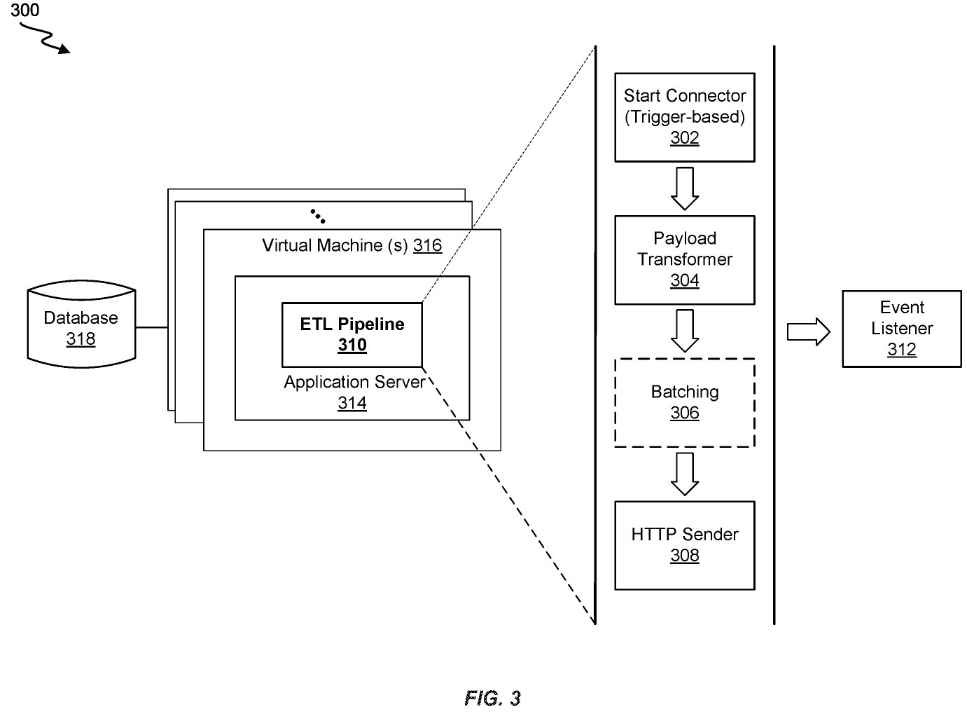

FIG. 3 shows an illustrative example of a connector module architecture 300 for processing data from a digital record repository 102 in accordance with some aspects of the present disclosure. The exemplary architecture 300 may be deployed on-premises or in the cloud and is capable of interfacing with various external services or other components of the disclosed data exchange architecture. The exemplary architecture may access or store digital records in a database 318 e.g., SAP DB and run within a virtualized environment 316 that hosts an ETL (extract, transform and load) pipeline 310 and an application server 314. The ETL pipeline is responsible for structured data operations such as extraction, transformation, (e.g., converting names to uppercase) and loading into appropriate storage or downstream systems. This pipeline enables the retrieved digital records (e.g., customer data) to undergo a variable number of operations before being transmitted to the connector module 110. As an example, SAP DB, a structured collection of subject data that helps the system in processing and analyzing it, can be used to feed the subject data to the ETL pipelines 310. Message standardization and security can also be the purpose behind the implementation of these pipelines.

The process of ETL pipeline 310 may begin at block 302, where a start connector may be triggered based on an event, schedule or manual initiation. The event, system-generated or user-initiated, typically originates from changes or actions in the DRR 102, corresponding to a triggering condition or occurrence that signals the need for data processing or transmission. For example, requests comprising creation or update of a digital record, as scheduled time-based export job, an access request, a bulk export, a backfill request from a service platform, or a manual synchronization request initiated by an administrator. The event trigger may initiate the ETL pipeline 310 leading to a response, which may comprise a payload including relevant digital records accessed from a database 318. In some examples, however, the event response may not include a payload, if the event is only signaling a state change or a required action without the need for data transfer. When the event includes a payload, the event response (or message) may refer to a structured data payload that is generated or collected as a result of the event. The payload may include content to be transformed and transmitted such as customer records, financial documents, healthcare data (e.g., subject lab results or demographics) or any domain-specific data unit. The payload in ETL pipeline 310 may undergo the transformation by a payload transformer 304 that performs one or more conversions or formatting using domain-specific schemas (e.g., JSON, XML, HL7 or FHIR) depending on the compliance with standards in place such as HIPPA, FHIR, ICD-10 or GDPR.

The payload fetched from the database 318 may include some redundant parts for processing, therefore, to filter such parts, payload transformer 304 may incorporate a data cleaner that, in addition to filtering, may remove duplicates and re-query the missing values. The standard defined by different sectors serves various purposes ranging from ease of integration to data security. FHIR standards, as mentioned above, focus on seamless exchange of records whereas the HIPAA and GDPR standard correspond to the security of personal data associated with customers, users or subjects such as patients. The ETL pipeline 310 may employ TLS (transport layer security) to further enhance data encryption. Before processing data, HIPAA standard may require de-identifying the record by masking personal identification information (e.g., name, social security number) with anonymous data. Further security includes standards and methods such as OAuth, RBAC, Safe Harbor Rule, Pseudonymization etc.

After generation or conversion to a standardized format, the event response (or message) may optionally undergo batching 306 that performs the process of grouping one or more data records together and considering them as a single unit. The batching 306 may provide efficiency by reducing overhead of dealing with data items individually thereby enhancing resource utilization in data processing, streaming and workflow automation systems. The high-volume of data transfer requests may culminate in low latency and network congestion and to alleviate it, ETL pipeline 310 may integrate batching 306. For example, Kafka, a distributed event streaming platform that may serve as a platform to build pipelines, can accumulate multiple messages in single batch grouped together such that it forms single network request. This reduces the overhead of multiple TCP/IP calls thereby assisting in real-time handling of the requests. The formatted message or batch may be transmitted to HTTP (hypertext transfer protocol) sender 308 that is responsible for initiating communication over HTTP format (or other protocols) for sending messages to other systems outside such as source entity. The HTTP sender 308 may interact with the connector module 110 via a sub-component of Eastbound connector 202 namely event listener 312 that on retrieval of HTTP request may trigger an associated operation.

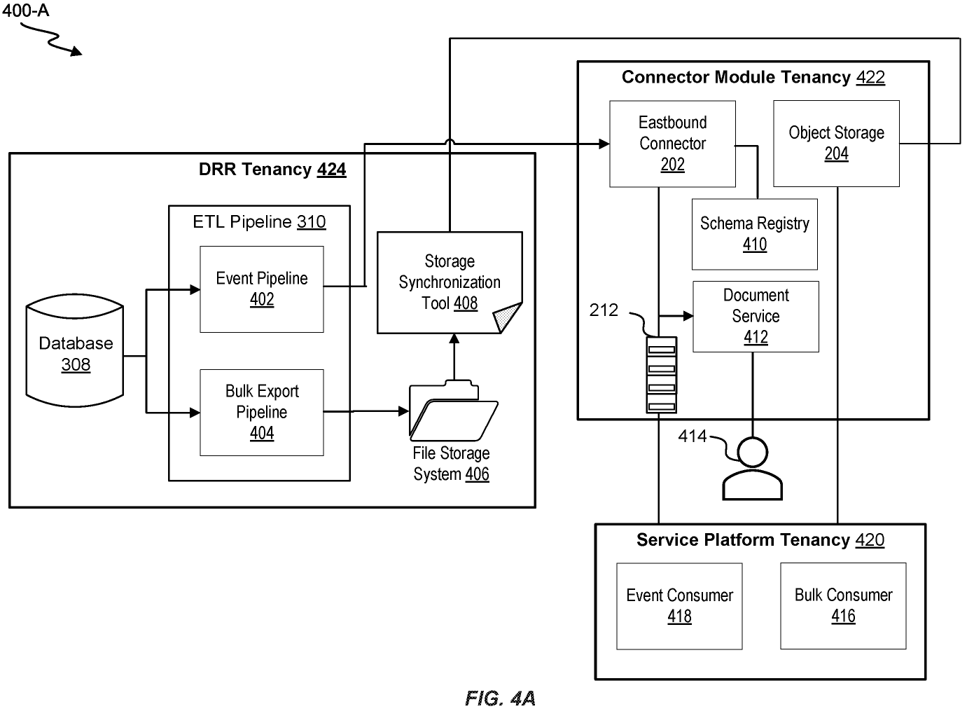

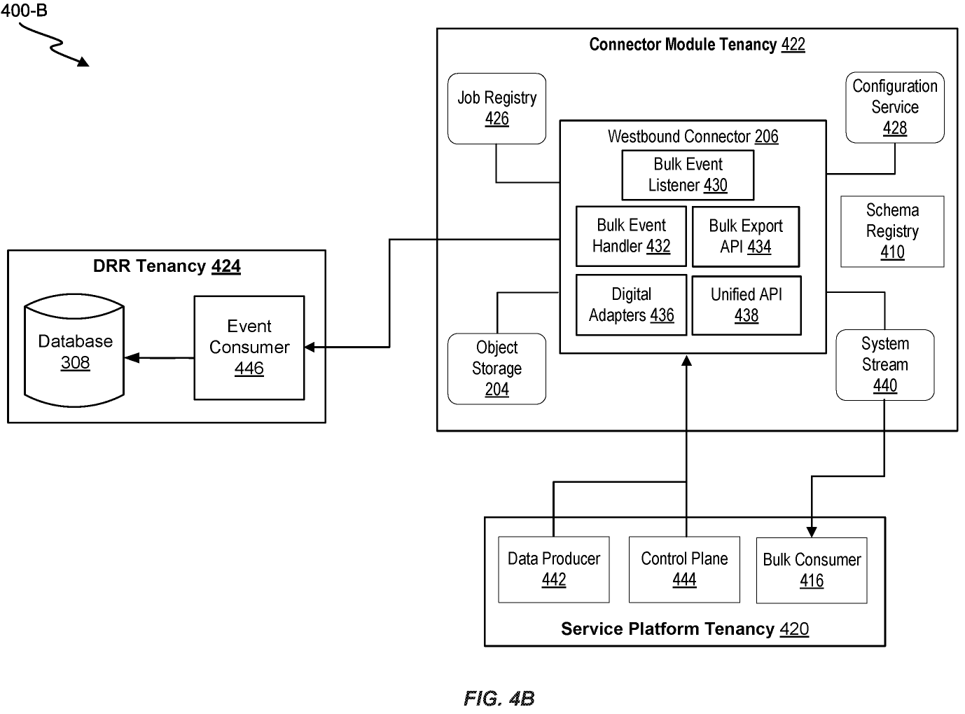

FIG. 4A illustrates an exemplary architecture 400-A for managing and facilitating data exchange (or messages) between a digital record repository (DRR) and source entities 10 (e.g., external service platforms) using a connector module, particularly in a multi-tenancy environment. The exemplary architecture 400-A includes a DRR tenancy 424, a connector module tenancy 422, and a service platform tenancy 420, each representing logical or physical isolation zones supporting data flow between various components. In this context, “tenancy” refers to a logical separation of system components, users, or services that operate within the same infrastructure but maintain isolated operational boundaries. For example, one organization or business entity may have its own tenancy to control data access, processing, and storage independently of others—even though these business entities may share the underlying hardware or platform.

In a broader aspect, when a source entity such as a service platform or external system needs to backfill data from the digital record repository (DRR) 102, it sends a backfill request or backfill message specifying the missing digital records or historical information it needs. Upon receiving the backfill request, the connector module 110 (or any middleware) processes it and extracts the requested data from the DRR 102, comprising a message. The message may then be stored in a designated location (e.g., object storage 204) and the source entity is notified through a notification stream (e.g., system stream 212) indicating the availability of the backfilled data. The details of various supporting components during the backfill request are explained in detail below.

Within the DRR tenancy 424, the database 318 stores digital records such as structured and unstructured data of the business entity or from external systems. As discussed earlier, the ETL pipeline 310 may facilitate data transformation and transmission, where separate ETL pipelines are assigned to different types of data flows. For example, an event pipeline 402 is dedicated for real-time or incremental data changes (e.g., triggered via event-based mechanisms such as a change in DRR state or on a command (request) from the service platform), while a bulk export pipeline 404 supports large-scale data export operations, such as backfill. The separation of the event pipeline 402 and the bulk export pipeline 404 provides isolated transfer of events and bulk export data thereby managing both responses in parallel and isolated manner. A storage of storage synchronization tool (SST) 408 (e.g., Rclone) may coordinate the transfer of bulk export data between file storage system (FSS) 406 of the DRR tenancy 424 and the object storage 204 of the connector module tenancy 422. The FSS 406 may handle intermediate or mounted volumes used in bulk export pipelines 404 or workflows. Before sending the bulk data to the connector module 110, the bulk pipeline 404 uploads the bulk response data to FSS 406. The bulk pipeline 404 may group together data into the batches before storing it into FSS 406.

The FSS 406 and storage synchronization tool 408 (e.g., Rclone) may operate in a cloud-based, on-premises, or hybrid computing environment. For example, the FSS may be a network file share (e.g., NFS, SMB) deployed in a private datacenter or a cloud-hosted file storage service. Similarly, the storage synchronization tool 408 may be executed in an on-premises connector module to replicate or migrate files to a remote object storage 204 or may operate in a fully cloud-based setting. The architecture thus supports deployment flexibility while maintaining logical tenancy boundaries for export pipelines and consumer access.

The connector module tenancy 422 comprising Eastbound connector 202 listens to incoming events or commands (requests) from the DRR tenancy 424. The object storage 204 may receive bulk exported data from the FSS 406 of the DRR tenancy 424 and exposed to the service platform tenancy 420. This object storage 204 may represent a dedicated bucket allocated per tenant, used to store large data objects such as exported master data, reference data, or documents. Master data typically includes data entities such as patients, customers, or employees e.g., a patient record with their name, identifier (ID), and contact details. Reference data, on the other hand, includes standardized values that support those records, e.g., a list of gender types, diagnosis codes, or country codes used within patient records. While master data describes “who” or “what”, reference data defines the allowable values or categories used to describe the master data. The ETL pipeline 310 may share multiple events to the REST API provided by the Eastbound connector 202. An event listener, on receiving the events from the DRR tenancy 424, may validate the event response and share it with the event bus. The DRR 102 may send the response in a structured format that a schema registry 410 will validate. The schema registry 410 may hold a plurality of schemas associated with one or more messages shared by the digital record repositories 102a-n and the source entities 106. The schema registry 410 may be used for validating the message (request or response) received from both DRR 102 and platform services 108, schema versioning, backward & forward compatibility validation, and so on maintains data structure definitions and validation schemas.

A document service 412 within the connector module tenancy 422 may work with object storage 204 for sharing large documents or files. Large documents or files such as images, PDFs, etc. are stored in the object storage 204 as binary objects, which are not delivered over the event stream 212. Moreover, these objects are not directly available to a user 414 for download from the object storage 204 without authorization or authentication. In some examples, it may be inefficient to pass over large binary objects across multiple services 108. Instead, the large binary objects are managed by the centralized document service 412 that will store the documents (or binary objects) in the object storage 204 fetched from the DRR 102. The document service 412 may pass a document reference to a receiving entity e.g., an authorized user 414, service 108, or source entity. When the receiving entity needs access to the document content, it will be fetched from the DRR database 318 through the bulk export pipeline 404, stored in object storage 204 (e.g., via FSS 406 and SST 408) and made available for retrieval over the object storage 204. The document service 412 may manage the permission where the user 414 may authorize itself before accessing the data. Upon authorization, document service 412 may pass over the document reference object comprising user information and document identifier (ID). The object storage 204 may expose the REST API on service side that service or user 414 may call to download the document.

Within the service platform tenancy 420, the bulk consumer 416 retrieves and processes data exported via the bulk export pipeline 404. The event consumer 418 listens for and processes real-time or incremental data updates received from event stream 212 that the events received from the digital record repository 102. The event consumer 418 may listen to the event stream 212 (e.g., via an API call to the connector module 110) and direct the events to one or more services 108. For example, events such as change in state of DRR or availability of lab results from the DRR 102 that are requested by a service (e.g., HIM or OHPACT) or service platform may channel through the event stream 212 to the one or more event consumers 418. Likewise, bulk consumer 416 manages the bulk export data from the object storage 204 analogous to the event consumer 418 e.g., in response to a request with bulk data such as backfill or on-demand. The connector module 110, upon a call from the bulk consumer 416, may send data stored in the object storage 204. The service platform (or source entity) 106 running one or more services may follow diverse approaches to implementing these services such as using a single event consumer for multiple services or isolating the event consumer for each service running on the source entity. Though different approaches may affect the data rate and load on the source entity, the solution herein offers flexibility for the source entity to use either approach subject to the choice of system integrator.

There are several strategies that an event consumer 418 on the service platform tenancy 420 may implement to handle unexpected events. For example, when the event consumer 418 detects missing data, it may opt to put the message back into the queue for redelivery, enabling that the pipeline continues without interruption while the bulk export consumer proceeds with consuming the remaining data. Alternatively, the event consumer 418 may choose to skip events related to unknown resources, such as missing or unregistered subject records. In such cases, the event consumer 418 may later backport the most up-to-date information by fetching it from the FHIR API, enabling maintenance of data integrity while allowing the pipeline to progress without delays. This approach may enable the system to remain flexible and resilient, adapting to data inconsistencies or unexpected gaps.

FIG. 4B shows an exemplary architecture 400-B for directing requests from the source entity to the digital record repository (DRR) 102. The source entity, e.g., including a service or interconnected services (e.g., service platform) may initiate several types of requests or messages to interact with a DRR 102 in the DRR tenancy depending on the data flow required. For backfill requests, the source entity may request historical or missing data that was not previously synchronized, either in an initial backfill (all missing data), partial backfill (specific records for time periods), or incremental backfill (new or updated data since the last synchronization). In on-demand retrieval, the service platform may request specific data as needed, such as retrieving a single record (e.g., patient details) or a batch of records for processing in bulk. For write-back, the source entity may send updated or new data back to the DRR 102, which could include subject updates, transaction records, or financial documents. Lastly, in change-event streaming, the source entity may subscribe to or request notifications about data changes in the DRR 102, such as new subject records or updated billing information, to enable real-time synchronization and continuous data flow. These various requests enable seamless data exchange and maintain synchronization across different types of operations between the source entity and DRR 102.

Within the service platform tenancy 420, a data producer 442 may be responsible for generating messages (or requests) in accordance with a predefined schema, which defines the structure and format of the data being exchanged. The connector module 110 may validate whether these messages conform to the predefined schema, verifying their compliance. Each generated message may undergo validation by the schema registry 410 associated with the connector module 110. Additionally, the connector module 110 may maintain consistency for data entity types such as subject records or demographics data. This consistency across different digital record repositories (DRRs) may help in smooth communication. There may exist three communication mechanisms including, the event stream 212, a unified API, and a bulk export API. As discussed earlier, the event stream 212 enables real-time communication by transmitting immediate notifications when events or changes occur in the DRR. For example, any updates to a subject’s records may be instantly conveyed to the source entity or service platform for further processing. The unified API 438 (or DRR REST API) may provide on-demand access to data retrieval and write-back capabilities, allowing the source entity to retrieve or send updates such as subject data or clinical records in real-time. The bulk export API 434 may enable scheduling large data exports, including both initial imports and on-demand backfill of missing or historical data. These mechanisms may provide efficient data transfer, particularly when significant volumes of data need to be synchronized across systems.

The configuration service may contribute to managing the communication channels between the source entity and the DRR 102. It specifies the details for accessing the services required for each client or business entity, enabling establishment of correct data flows. This includes information such as access credentials and service-specific configurations. By handling these configurations, the service enables secure and efficient data transfers, tailored to the specific needs of each business entity. The configuration service 428 may act as a central hub, coordinating and facilitating the various communication channels (such as the event stream 212, unified API 438, and bulk export API 434) for smooth and reliable data exchange between the source entity and the DRR 102.

For change event stream operations or data flow, Eastbound connector 202 may also be referred to as the event bus for the real-time data flow. From source entity end, event bus may expose the event stream 212. From DRR end, the event bus may expose an event listener that will forward events to the event stream 212.

Before initiating the backfill operation, the event bus or the Eastbound connector 202 is provisioned and configured to accumulate DRR events. This process may eventually be automated through a control plane 444, but initially, it will be handled manually and coordinated by a service engineer or administrator. Upon the detection of availability of the event bus for accumulation of subsequent events, the control plane 444 may send a notification (a small payload) from the service platform tenancy 420 to the Westbound connector 206 via a bulk export API 434 to scheduled operations such as the bulk export, writeback or on-demand data retrieval. In response, the bulk consumer 416 may be started and prepared to process the data. At the same time, the event consumer 418 may remain active, continuously accepting and processing incoming data e.g., real-time event notifications or updates—such as new records or modifications— as needed.

For execution of events (or jobs) in an ordered manner, an job registry 426 may include a list and status of jobs or events. A bulk event listener 430, accepting new events from the job registry 426, may trigger the bulk event handler 432, a sub-component within the Westbound connector 206 responsible for monitoring the new object in the object storage 204 and notifying the service tenancy 420 about the availability of the new object via the system stream 440. The system stream 440, upon receiving the notification from the bulk event handler 432, may notify the bulk consumer 416 about the availability of data in the object storage 204. The bulk consumer 416 proceeds to fetch object by calling the REST API associated with the object storage.

Once the new object is available in the file storage system (FSS) 406, the bulk event listener 430 associated with the connector module 110 may trigger a series of processes (or jobs). It may emit a job by sending a notification (e.g., a bulk_export_object event) via the bulk event handler 432 to the system stream 440. The bulk_export_object event may include metadata such as a request ID and the object location (e.g., namespace, bucket, and object name). The bulk event listener 430 may begin a copy job for copying the new object and optionally perform data encryption job during the transfer (or the copy job) using the same encryption key used for encryption of the event stream 212. However, since each DRR tenant has a dedicated object storage 204, the data encryption job may not be required. The bulk event listener 430 monitors the copy progress, and if the copy job fails, it retries the copy operation. Upon success, a bulk_export_failed event may be emitted, and the copy job is abandoned. If the copy job succeeds, the bulk event listener 430 may emit a bulk_export_object_complete event, which provides the same information to the bulk consumer 416, enabling that the bulk consumer 416 does not need to persist the metadata while waiting for the copy job to complete. Finally, the new object is moved to a different location e.g., the object storage 204, outside the scope of the bulk event listener 430 monitoring, but it remains within the object storage 204 until a retention period.

After the bulk export is completed, the ETL pipeline 310 may generate a completion marker, such as export_complete. When the bulk event listener 430 detects this marker or signal and confirms that no other objects remain in the export location, it triggers an event to the export notification stream, e.g., export_complete. The bulk consumer 416 listens to both the export_object_complete and export_complete events and takes the appropriate actions. Upon receiving these events, the bulk consumer 416 processes the exported data and transfers it further along the ETL pipeline 310 for subsequent operations.

To facilitate seamless integration across various source entities, a unified API 438 is implemented, capable of receiving requests from multiple services directed at multiple digital record repositories (DRRs) 102. Upon receiving a request through this unified API 438, the connector module 110 validates the request schema using the schema registry 410. The request, structured according to defined data models, is then processed by the unified API 438 for validating compatibility with multiple DRRs 102. To enable this, the unified API 438 includes a set of digital adapters 436, each leveraging data models that define data entities (representing real-world objects such as customers, patients, products, or employees), fields, and relationships between these data entities. For instance, in a retail scenario, the data entity “Customer” may represent an individual with attributes such as name, contact details, and purchase history, while the “Product” entity could include attributes such as product ID, description, and price. Relationships between these entities may be defined, such as one-to-many, where a single customer can have multiple orders.

In a healthcare context, similar relationships may exist between “Doctor” and “Patient”, where a doctor may be responsible for multiple patients. When a request is received via the unified API, it is forwarded to the relevant digital adapter 436, which converts the request into a format compatible with the target DRR 102. A digital adapter uses a specific data model for its corresponding DRR such that the request is appropriately formatted and delivered. This method may provide ease of integration, offering standardized requests across multiple source entities and enabling efficient communication with various DRRs.

When the connector module 110 receives a request from the source entity (e.g., PAS), which is directed to the DRR (e.g., i.s.h. Med), the connector module 110 directs this request to the appropriate digital adapter, such as the i.s.h. Med adapter, from the set of available digital adapters. The i.s.h. Med adapter is responsible for transforming the incoming request for complying with a schema required by an event consumer (e.g., ODATA API). This transformation may include structuring the data according to the expected format, converting field names, and mapping relationships between data entities (e.g., converting PAS patient records into the format expected by the EHR). Once transformed, the i.s.h. Med adapter sends the request to the event consumer 446, which can efficiently process it within the DRR system. the event consumer 446 of the DRR tenancy e.g., an ODATA API, which is a standardized interface used within an EHR system to accept requests from a source entity such as patient administration system (PAS). This process allows for seamless integration between PAS and the EHR, enabling that data is properly formatted and routed for processing according to system-specific requirements.

For writeback operations, the source entity may communicate to DRR 102 over the unified API 438 that will expose unified API contract & data model. The unified API 438 has concrete digital adapters 436 that can translate unified API 438 into specific API calls (or multiple API calls) to the DRR system.

The backfill request comprises a plurality of jobs where the order of execution and type of jobs may dynamically adjust based on the execution of previously executed tasks. The dataflow in backfill may adhere to CQRS, a software architecture pattern that separates the read and write operations. For example, for the connector module 110 data flows, write operations may direct through the Westbound connector 206 whereas the Eastbound connector 202 handles the read operations.

For backfill, the source entity e.g., a service may put backfill command to the unified API 438 for handling the data and event requests from service side. In addition, apart from sending data to the unified API 438, for instance, the source entity such as PAS may employ event consumer 446 to receive request about the backfill operation from the system stream 440. The connector module 110 may offer a flexible approach for specifying backfill command format. However, to compensate for the rigid nature of the digital record repositories 102a-n such as i.s.h. Med, the solution may incline towards assigning distinct destination pipeline (a pipeline to handle the flow of command received from service side) to each destination system. For instance, one pipeline for PAS data, and one pipeline for HIM data, etc. The latent representation suggests further breaking the pipelines into a more distinct set to reduce changes on the connection side while integrating.

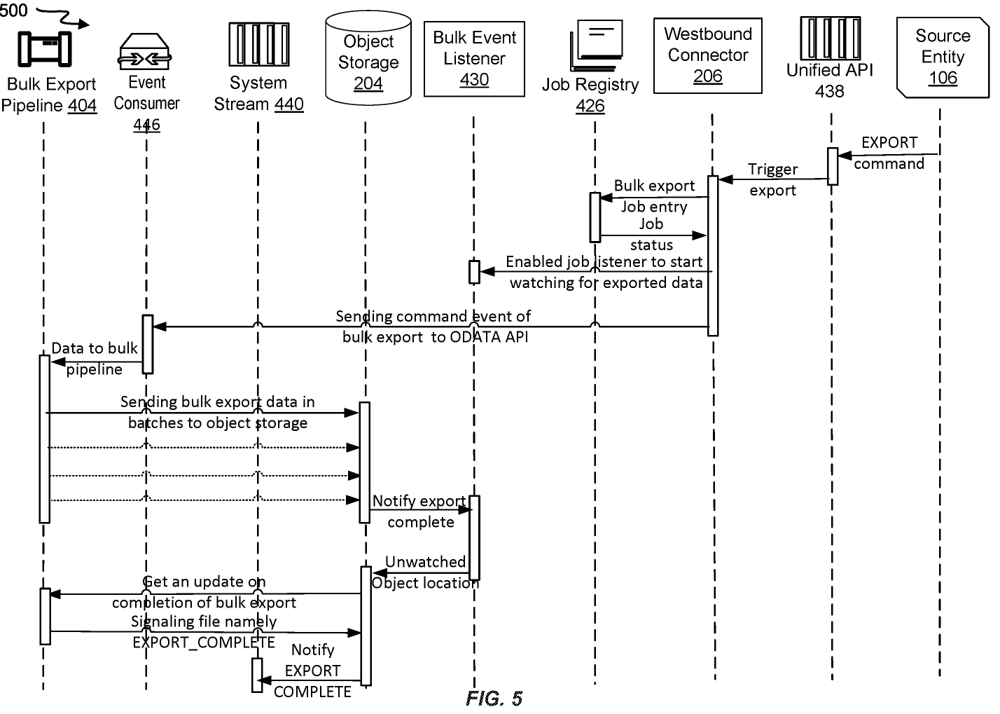

FIG. 5 describes an exemplary sequence diagram 500 illustrating exchange of messages (a term encompassing the request and the response) between the connector module 110 and the source entity to perform the backfill operation. The operation starts as soon as the source entity such as PAS, via a prompt from a user, may request the backfill data (e.g., by sending an EXPORT command) to the unified API 438 associated with the Westbound connector 206. The job registry 426 within the connector module may register the export job and its status. The status herein informs the bulk event listener 430 whether the export job is ready to consume or not. The bulk event listener 430, upon the status of export job to be set running, may start monitoring the exported data (backfill data from the DRR 102) in the object storage 204.

The command sent from the source entity may undergo transformation by a specific digital adapter to make it compatible with the particular DRR. The event consumer 446 of the DRR, upon receiving the command (or event) from connector module 110 may trigger the bulk export pipeline 404. The mounted volume (the FSS 406) may act as intermediate storage inside the DRR 102 for the objects directed to the connector module 110. It is coupled with the SST 408 that sends the objects to object storage 204. The SST 408 may include a mechanism such as semaphores, where the SST 408 may only transfer the files that do not hold a semaphore in contrast to those that do. For transfer of file to the object storage 204, bulk event listener 430 may emit the event (e.g., export_object_complete) including the meta information such as job request ID, namespace, object location, bucket and object name. The bulk event listener 430 then starts copying the data to object storage 204. To enhance security, few representations incorporate the encryption during the copy as the transfer messages might get exposed on unsecure channel. Meanwhile, the bulk event listener 430 may monitor the copy progress and if there is any failure midway, it may retry the export for defined number of times before emitting (e.g., export_failed) event and abandoning the job.

Upon the successful transmission of file, the bulk event listener 430 may emit another event (e.g., export_object_complete) providing same meta information so that consumer may not require to persist this information till completion. It may then move an object inside the object storage 204-a from export location to another location, where the bulk event listener 430 may not monitor the object. The object stored in the latter location may incorporate the retention period, a span of time till which the object may not be deleted by the object storage 204. Once the export job is completed, the bulk export pipeline 404 may send another file namely “EXPORT_COMPLETE’. The bulk listener 430, on detection of (e.g., export_complete), may emit the event to the system stream 440, (e.g., export_complete). The event consumer 418 of the service platform tenancy 420 on service end may read both export_object_complete and export_complete event and take the appropriate action such as transferring the object from the object storage 204 to its internal pipeline.

Furthermore, besides the functional aspect of data flow from one end to another, the implementation adheres to protocols with additional provision to achieve design consistency. For instance, during the export command event from the source entity, the connector module 110 may skip the request due to network instability either at the connector end or service end thereby arising the requirement to add feature such that each request is directed to the connector module 110 whether bulk export or any other may deliver at least once where duplicate can happen. Analogously, the response directed to service from the Connector module 110 may follow suit. Moreover, additional provisions incorporated in the representation may ensure the delivery to be exactly once thereby offering the design to entertain the request and the response without a miss.

When it comes to large object delivery such as in case of backfill, the provision, analogous to event delivery approach, ensure the large object delivery to be sent exactly once but the large object delivery may bring additional challenges to handle as it interacts with destination system with independent data handling. The connector module110 may deliver the large object more than once to the destination system. The source entity, on receiving multiple large objects, is preferred to support the idempotent produce. The idempotent process described herein refers to an action performed by the source entity, where handling multiple large objects yields the same outcome as handling a single large object. Another provision suggests that objects from one or more object storage 204 can be overwritten by any other object but the data inside these objects may remain the same. For the one or more digital record repositories 102a-n, there may exist a case where bulk export machinery might be AD local with object storage 204 on regional end. To handle such cases, the bulk listener 430 may track the moved objects inside object storage 204-a.

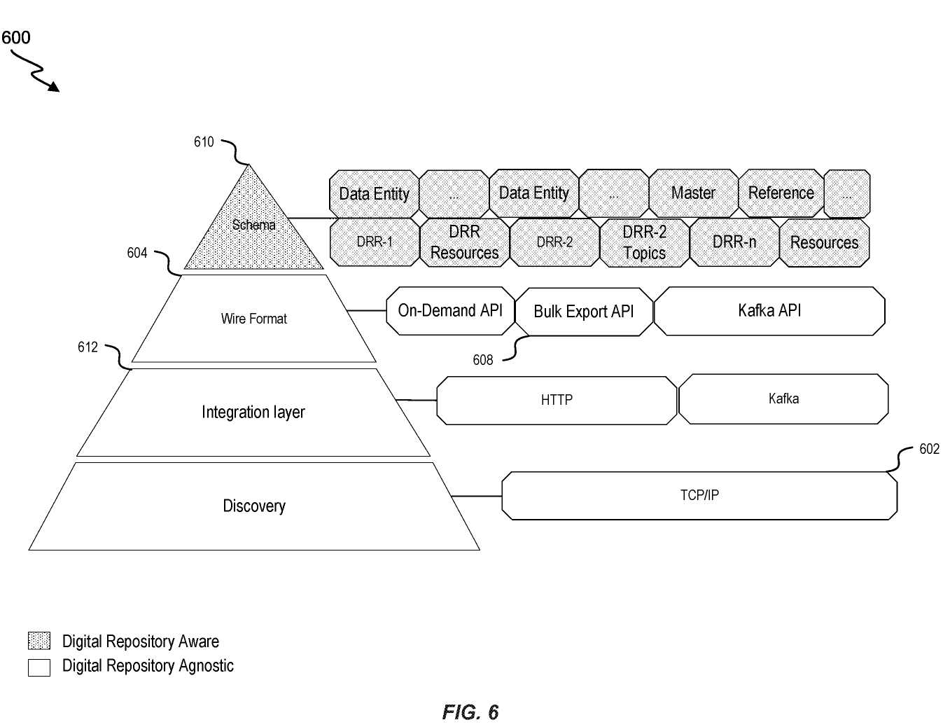

FIG. 6 shows an exemplary layered stack 600 employed within the connector module 110 for transmission and reception of the messages. The layered approach may not intend to cover functionality rather it aims to highlight a broader scope of integration of a new DRR 102. For example, when the new DRR 102 is incorporated into the business entity having multiple DRRs 102a-n, the connector module 110, comprising of middleware components to validate the schema of each request associated with the particular DRR 102, may not require adaptation of each layer included in the layered stack 600. Rather the connector module 110 provides ease of adaptation by reducing the dependence on the DRR 102 such that one or more layers may not require adaptation with the new DRR 102.

The connector module 110 may receive the message on transport layer (layer 4 of OSI model) via TCP/IP protocol 602, which corresponds to a DRR-agnostic layer. Upon receiving the message (request or the response e.g., event or bulk data), a TCP/IP 602 protocol suited for reliable communication may work in conjunction with transport layer security (TLS) protocol to preserve the integrity of the message received. The message then may be forwarded to the integration layer 612 (DRR-agnostic) including HTTP or Kafka, where the integration layer 612, incorporating software components for handling the message, offers bi-directional communication between the connector module and other systems (such as the DRR 102 and the source entity). The HTTP protocol follows request-response model where the message (following HTTP standard) from either the source entity or the DRR 102 can be handled and directed to the corresponding API.

Analogously, the Kafka, following the publish-subscribe model, provides the real-time handling of the message thereby making it suitable for handling the event response directed from the DRR 102 to the source entity. However, both integration protocol (Kafka or HTTP), on receiving the message, direct it to the corresponding API for processing the contents of the received message. The APIs, including Kafka, REST or unified API, may reside in the layer namely a wire format 604 that too is DRR-agnostic. The wire format 604 processes the content of the received message such as: for backfill or on-demand retrieval request, the wire format may enable the REST API (associated with the object storage 204) and the unified API 438; for change in state of the repository, it may enable the Kafka API associated with the event stream 212. These APIs, on processing the message, may direct the message to the components such as the Eastbound connector 202, the Westbound connector 206 or the object storage 204.

The unshaded layers in FIG. 6 that have been discussed till now can be considered DRR agnostic. The message flows to and from any DRR 102 may not influence these layers but a schema layer 610 (a shaded layer in FIG. 3) may rely on the DRR 102. The schema layer 610 includes a set of data models where each data model associates with the schema of the DRR 102. Upon receiving the request associated with the particular DRR, the connector module 110 may use the data model associated with the particular DRR 102 to perform schema transformation. Furthermore, the validation performed by the schema registry for the messages directed from both the DRR 102 and source entity also falls in the schema layer 610. Therefore, during integration of new DRR 102, the connector module 110 may require incorporating transformation and validation of the schema associated with the new DRR 102.

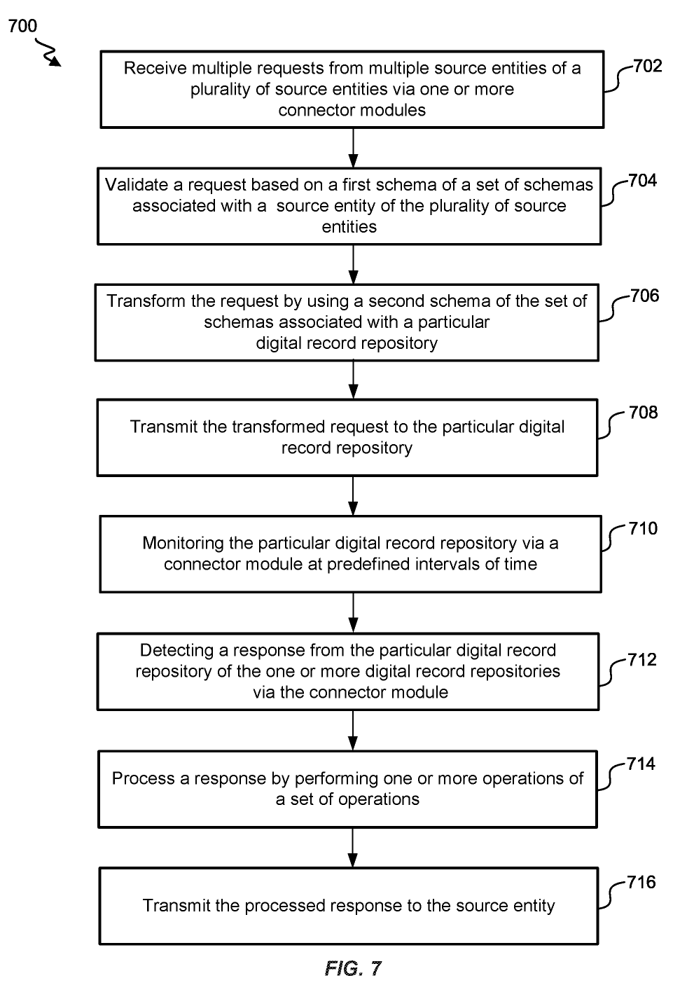

FIG. 7 illustrates an exemplary workflow 700 to handle the request received from the source entity via the connector module 110, transmit the transformed request to the DRR 102 and direct the response from the digital record repository 102 to the source entity. The blocks in the exemplary workflow 700 are illustrated in a specific order, while the order can be modified, for example, some blocks may be performed before others, and some blocks may be performed simultaneously. The blocks can be performed by hardware, software, or a combination thereof. At block 702, one or more connector modules 110a-n comprising the set of middleware components between source entities 106 and digital record repositories 102a-n, may receive multiple requests from multiple source entities 106 directed to one or more digital record repositories 102 where each connector module 102 exposes the unified API 438 for receiving the request. The unified API 438 following the defined schema offers ease of integration by providing a common API interface to handle the multiple requests from the multiple source entities 106. The Westbound connector 206, within the connector module 110, a middleware component between the source entity and digital record repository, receives the request. The request may or may not comply with a first schema of a set of schemas associated with the received request and to validate the first schema associated with the request, the connector module may invoke the schema registry 410.

At block 704, the schema registry 410 performs validation and upon successful validation by the schema registry 410, the request is forwarded to the digital adapter of the set of digital adapters. Each DRR 102 may request the request following a second schema of the set of schemas, therefore the connector module 110 may use the digital adapter associated with the DRR 102. At block 706, the digital adapter of the set of digital adapters utilizes the generated data model to transform the request to comply with the second schema of the set of schemas associated with the DRR 102. These data models, each associated with the particular DRR 102, may be generated either manually, through AI or a combination thereof, by considering the set of schemas corresponding to digital record repositories. At block 708, the connector module 110 upon transformation of the request may transmit it to DRR 102 by calling an API associated with the request exposed by the DRR 102. The DRR 102 may include multiple pipelines and based on the received request from the connector module, it may invoke the pipeline associated with the received request. At block 710, one or more listeners of the connector module 110 keeps monitoring the DRR for handling the response generated by the DRR 102. The response can either include the event directed to the event consumer 418 of the source entity or it may include the bulk data directed to the bulk consumer 416 of the source entity. Upon detecting the response at block 712, The connector module 110, based on the response, may perform one or more operations of a set of operations. At block 714, the connector module perform the one or more operations where each operation is associated with the response received by the DRR 102. For example, for the backfill request, the set of operation includes running a job for continuously or periodically listening to the object storage 204 while the bulk response associated with the bulk request may channel through SST to the object storage.

After successful transfer of the bulk data to the object storage 204, the connector module 110 notifies the bulk consumer 416 of the source entity about the availability of the backfill data in the object storage 204 using system stream 506 and the connector module 110, at block 716, may transmit the bulk data to the source entity. Similarly, for change in state of the DRR 102 or for successful transfer of writeback data from the source entity to the DRR 102, the response may direct to the source entity via the event stream. However, prior to transmitting the response associated with writeback or change in state of the DRR, the schema registry may validate the response using the second schema of the set of the schemas. The connector module 110, at block 716, may transmit the response from the event stream to the source entity. Moreover, the connector module 110 , in addition to sending the request to the particular DRR 102 also includes the functionality to transmit the same request to the one or more DRR such as in writeback operation, the request (updating the DRR 102) include update via the source entity and one or more DRRs 102 may require updating the digital record associated with the request.

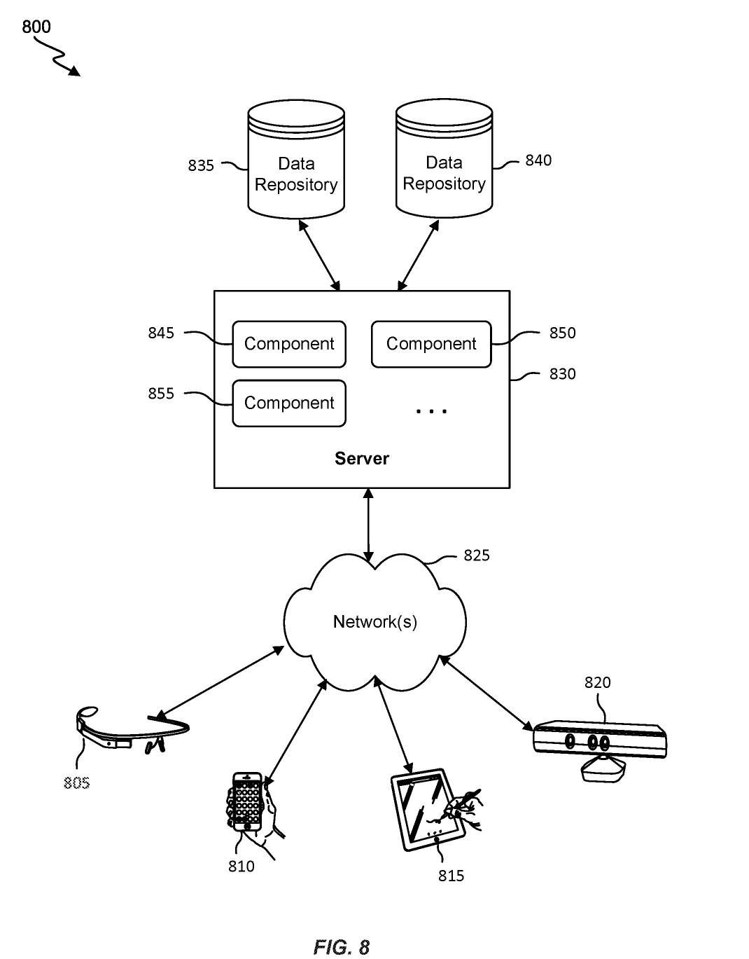

FIG. 8 illustrates a simplified diagram of an example distributed system 800 for a cloud hosting flexible data migration system. In the illustrated example, the distributed system 800 includes one or more client computing devices 805, 810, 815, and 820, coupled to a server 830 via one or more communication networks 825. The client computing devices 805, 810, 815, and 820 may be configured to execute one or more applications interact with the server 830 to access and utilize the payer platform securely integrated within a cloud environment, such as Oracle cloud integrated with Cohere. Within this framework, the server 830 is configured to host and manage a range of services or software applications, facilitating seamless integration and operation of the connector module 110.

In various aspects, the server 830 may extend its capabilities to encompass additional services or software applications. In some respects, these services may be offered as web-based or cloud services, such as under a Software as a Service (SaaS) model to the users of the client computing devices 805, 810, 815, and/or 820. Users operating the client computing devices 805, 810, 815, and/or 820 may in turn utilize one or more client applications to interact with the server 830 to utilize the services provided by these components. Furthermore, client computing devices 805, 810, 815, and/or 820 may in turn utilize one or more client applications to initiate and manage specific tasks or analyses.

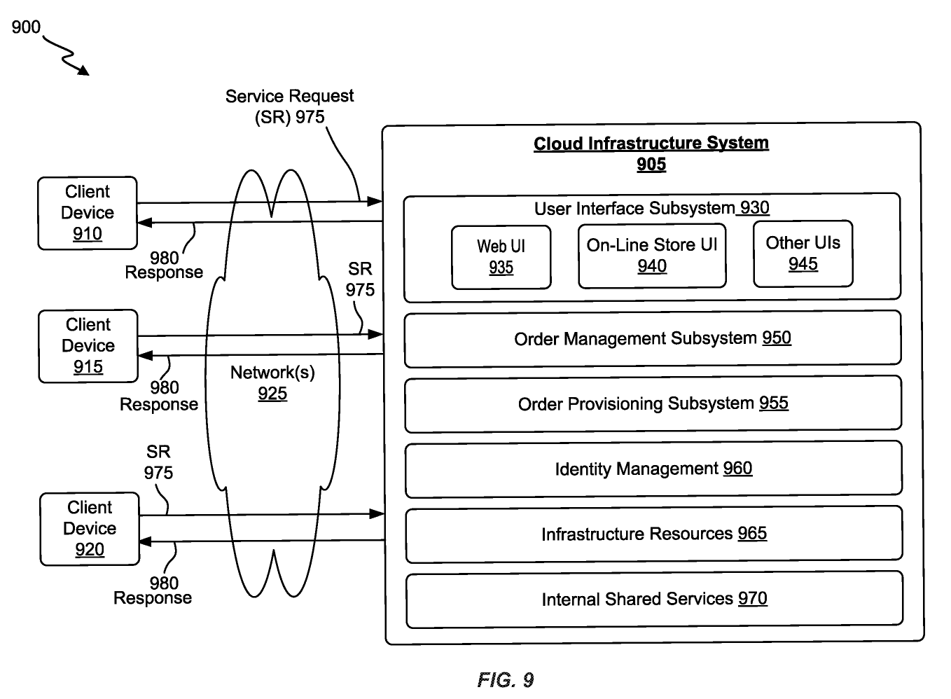

In the configuration depicted in FIG. 8, the server 830 may include one or more components 845, 850 and 855 that implement the functions performed by the server 830. These components may include software components that may be executed by one or more processors, hardware components, or combinations thereof. It should be appreciated that various system configurations are possible, which may differ from distributed system 800. The example shown in FIG. 9 is thus one example of a distributed system for implementing an example system and is not intended to be limiting.

Users may initiate requests through client computing devices 805, 810, 815, and/or 820 for inference or other machine-learning tasks. A client device may provide an interface that enables a user of the client device to interact with the source entity, a digital record repository or a service. The client device may also output information to the user via this interface. Although FIG. 8 depicts only four client computing devices, any number of client computing devices may be supported providing scalability and accessibility on the cloud.

The client devices may include various types of computing systems, such as portable handheld devices, general purpose computers, such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems, such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various applications, such as various Internet-related apps, communication applications (e.g., E-mail applications, short message service (SMS) applications) and may use various communication protocols.

Network(s) 825 may be any type of network familiar to those skilled in the art that can support data communications using any of a variety of available protocols, including without limitation TCP/IP (transmission control protocol/internet protocol), SNA (systems network architecture), IPX (internet packet exchange), AppleTalk®, and the like. Merely by way of example, network(s) 825 can be a local area network (LAN), networks based on ethernet, token-ring, a wide-area network (WAN), the internet, a virtual network, a virtual private network (VPN), an intranet, an extranet, a public switched telephone network (PSTN), an infra-red network, a wireless network (e.g., a network operating under any of the institute of electrical and electronics (IEEE) 1002.11 suite of protocols, Bluetooth®, and/or any other wireless protocol), and/or any combination of these and/or other networks.

The server 830 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The server 830 can include one or more virtual machines running virtual operating systems, or other computing architectures involving virtualization, such as one or more flexible pools of logical storage devices that can be virtualized to maintain virtual storage devices for the server. In various aspects, the server 830 may be adapted to run one or more services or software applications that provide the functionality described in the foregoing disclosure.

The computing systems in the server 830 may run one or more operating systems including any of those discussed above, as well as any commercially available server operating system. The server 830 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

Distributed system 800 may also include one or more data repositories 835, 840. Data repositories 835, 840 may reside in many locations. For example, a data repository used by the server 830 may be local to server 830 or may be remote from the server 830 and in communication with the server 830 via a network-based or dedicated connection. Data repositories 835, 840 may be of different types. In some instances, a data repository used by the server 830 may be a database, for example, a relational database, such as databases provided by Oracle Corporation® and other vendors. One or more of these databases may be adapted to enable storage, update, and retrieval of data to and from the database in response to structured query language (SQL)-formatted commands. In some aspects, one or more data repositories 835, 840 may also be used by applications to store application data. The data repositories used by applications may be of different types, such as, for example, a key-value store repository, an object store repository, or a general storage repository supported by a file system.

FIG. 9 is a simplified block diagram of a cloud-based system environment in which various services of the server 830 of FIG. 8 may be offered as cloud services, in accordance with certain aspects. In the illustrative example depicted in FIG. 9, cloud infrastructure system 905 may provide one or more cloud services that may be requested by users using one or more client devices 910, 915, and 920. Cloud infrastructure system 905 may comprise one or more computers and/or servers that may include those described for server 830. The computers in cloud infrastructure system 905 may be organized as general-purpose computers, specialized server computers, server farms, server clusters, or any other appropriate arrangement and/or combination.

Network(s) 925 may facilitate communication and exchange of data between client devices 910, 915, and 920 and cloud infrastructure system 905. Network(s) 925 may include one or more networks. The networks may be of the same or different types. Network(s) 925 may support one or more communication protocols, including wired and/or wireless protocols, for facilitating communications.

The illustrative example depicted in FIG. 9 is only one example of a cloud infrastructure system 905 and is not intended to be limiting. It should be appreciated that, in some other aspects, cloud infrastructure system 905 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network, such as the internet by systems (e.g., cloud infrastructure system 905) of a service provider. Typically, in a public cloud environment, servers and systems that make up the cloud service provider's system are different from the client's own on-premises servers and systems. The cloud service provider’s systems are managed by the cloud service provider. Clients can thus avail themselves of cloud services provided by a cloud service provider without having to purchase separate licenses, support, or hardware and software resources for the services. For example, a cloud service provider's system may host an application, and a user may, via a network 925 (e.g., the internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation® of Redwood Shores, California, such as middleware services, database services, Java cloud services, and others.

In certain aspects, cloud infrastructure system 905 may provide one or more cloud services using different models, such as under a Software as a Service (SaaS) model, a Platform as a Service (PaaS) model, an Infrastructure as a Service (IaaS) model, and others, including hybrid service models. Cloud infrastructure system 905 may include a suite of applications, middleware, databases, and other resources that enable provision of the various cloud services.

A SaaS model enables an application or software to be delivered to a client over a communication network like the Internet, as a service, without the client having to buy the hardware or software for the underlying application. For example, a SaaS model may be used to provide clients access to on-demand applications that are hosted by cloud infrastructure system 905. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a client as a cloud service to provide elastic compute and storage capabilities. Various IaaS services are provided by Oracle Corporation®.

A PaaS model is generally used to provide, as a service, platform and environment resources that enable clients to develop, run, and manage applications and services without the client having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, universally available, and secure manner. For example, a client, via a subscription order, may order one or more services provided by cloud infrastructure system 905. Cloud infrastructure system 905 then performs processing to provide the services requested in the client's subscription order. Cloud infrastructure system 905 may be configured to provide one or even multiple cloud services.

Cloud infrastructure system 905 may provide cloud services via different deployment models. In a public cloud model, cloud infrastructure system 905 may be owned by a third-party cloud services provider and the cloud services are offered to any general public client, where the client can be an individual or an enterprise. In certain other aspects, under a private cloud model, cloud infrastructure system 905 may be operated within an organization (e.g., within an enterprise organization) and services provided to clients that are within the organization. For example, the clients may be various departments of an enterprise, such as the Human Resources department, the payroll department, etc. or even individuals within the enterprise. In certain other aspects, under a community cloud model, the cloud infrastructure system 905 and the services provided may be shared by several organizations in a related community. Various other models, such as hybrids of the above-mentioned models may also be used.

Client devices 910, 915, and 920 may be of several types (such as client computing devices 805, 810, 815, and 820 depicted in FIG. 8) and may be capable of operating one or more client applications. A user may use a client device to interact with cloud infrastructure system 905, such as to request a service provided by cloud infrastructure system 905. For instance, a user might employ a client device to execute real-time data querying operations within the cloud. A client may use a client device, such as a laptop to interact with the Subject management system integrated within cloud infrastructure system. The client may request GPU-accelerated computing instances of the cloud for training deep learning models. The cloud may provide the necessary resources, and the subject client may monitor and manage the training process through the laptop. Upon completion, the client may retrieve the trained models and results.

In certain aspects, to facilitate efficient provisioning of these resources for supporting the various cloud services provided by cloud infrastructure system 905 for different clients, the resources may be bundled into sets of resources or resource modules. Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 905 may comprise multiple subsystems. These subsystems may be implemented in software, or hardware, or combinations thereof. As depicted in FIG. 9, the subsystems may include a user interface subsystem 930 that enables users or clients of cloud infrastructure system 905 to interact with cloud infrastructure system 905. User interface subsystem 930 may include various interfaces, such as a web user interface 935, an online store interface 940 where cloud services provided by cloud infrastructure system 905 are advertised and are purchasable by a consumer, and other interfaces 945. For example, a client may, using a client device, request (service request 975) one or more services provided by cloud infrastructure system 905 using one or more of interfaces 935, 940, and 945. For example, a client may access the online store, browse cloud services offered by cloud infrastructure system 905, and place a subscription order for one or more services offered by cloud infrastructure system 905 that the client wishes to subscribe to. The service request may include information identifying the client and one or more services that the client desires to subscribe to.

In certain aspects, such as the illustrative example depicted in FIG. 9, cloud infrastructure system 905 may comprise an order management subsystem (OMS) 950 that is configured to process the new order. As part of this processing, OMS 950 may be configured to: create an account for the client, if not done already; receive billing and/or accounting information from the client that is to be used for billing the client for providing the requested service to the client; verify the client information; upon verification, book the order for the client; and orchestrate various workflows to prepare the order for provisioning.

Once properly validated, OMS 950 may then invoke the order provisioning subsystem (OPS) 955 that is configured to provision resources for the order including processing, memory, and networking resources. The provisioning may include allocating resources for the order and configuring the resources to facilitate the service requested by the client order. The way resources are provisioned for an order and the type of the provisioned resources may depend upon the type of cloud service that has been ordered by the client. For example, according to one workflow, OPS 955 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the requesting client for providing the requested service.

Cloud infrastructure system 905 may itself internally use services 970 that are shared by different components of cloud infrastructure system 905 and which facilitate the provisioning of services by cloud infrastructure system 905. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like. As depicted in the illustrative example in FIG. 9, cloud infrastructure system 905 may include infrastructure resources 965 that can be utilized for facilitating the provision of various cloud services offered by cloud infrastructure system 905. Infrastructure resources 965 may include, for example, processing resources, storage or memory resources, networking resources, and the like. Cloud infrastructure system 905 may send a response or notification 980 to the requesting client to indicate when the requested service is now ready for use. In some instances, information (e.g., a link) may be sent to the client that enables the client to start using and availing the benefits of the requested services.

Cloud infrastructure system 905 may provide services to multiple clients in parallel. Cloud infrastructure system 905 may store information for these clients, including possibly proprietary information. In certain aspects, cloud infrastructure system 905 comprises an identity management subsystem (IMS) 960 that is configured to manage client’s information and provide the separation of the managed information such that information related to one client is not accessible by another client. IMS 960 may be configured to provide various security-related services, such as identity services, such as information access management, authentication and authorization services, services for managing client identities and roles and related capabilities, and the like.

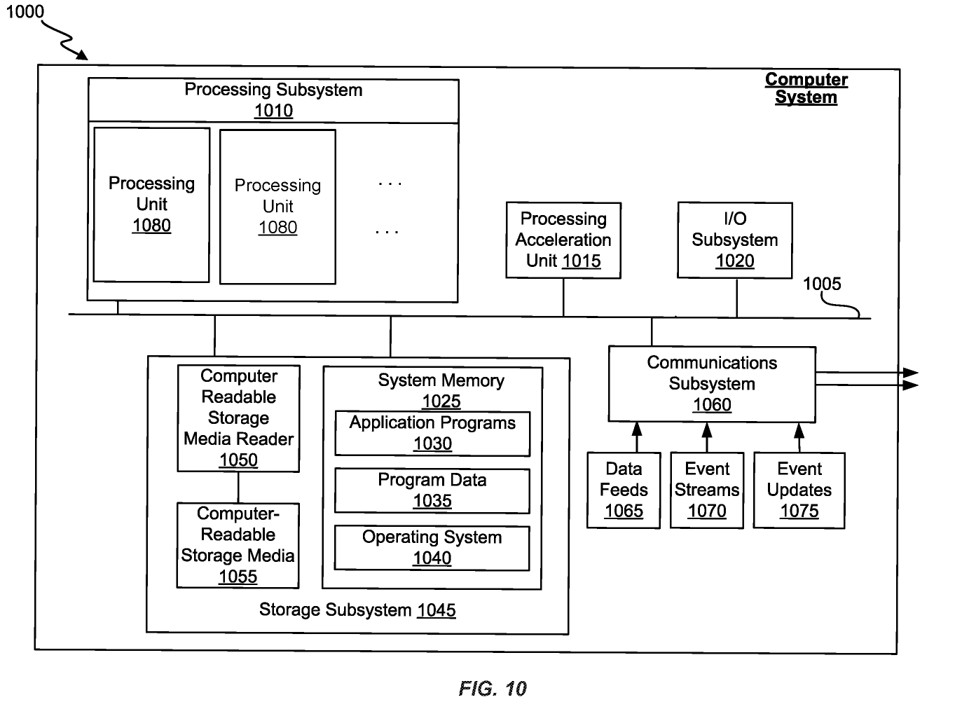

FIG. 10 illustrates an exemplary computer system 1000 that may be used to implement certain aspects of the present disclosure. For example, the computer system 1000 may facilitate interoperability between one or more digital record repositories (DRRs) and a plurality of source entities by executing one or more connector modules. The computer system 1000 may be configured to provision and manage system resources for processing data exchange requests, perform schema validation and transformation, handle secure communication via application programming interfaces (APIs), manage object storage operations, monitor performance of integration workflows, and enable scalable, low-latency data exchange across distributed environments. It may serve as the foundational infrastructure, enabling seamless deployment and operation of AI applications within the cloud environment while providing flexibility and scalability to adapt to changing computational demands efficiently. In some aspects, computer system 1000 may be used to implement various servers as described above. As shown in FIG. 10, computer system 1000 may include various subsystems including a processing subsystem 1010 that communicates with a few other subsystems via a bus subsystem 1005. These other subsystems may include a processing acceleration unit 1015, and I/O subsystem 1020, a storage subsystem 1045, and a communications subsystem 1060. Storage subsystem 1045 may include non-transitory computer-readable storage media including storage media 1055 and a system memory 1025.

Bus subsystem 1005 provides a mechanism for letting the various components and subsystems of computer system 1000 communicate with each other as intended. Although bus subsystem 1005 is shown schematically as a single bus, alternative aspects of the bus subsystem may utilize multiple buses. Bus subsystem 1005 may be any of several types of bus structures including a memory bus or memory controller, a peripheral bus, a local bus using any of a variety of bus architectures, and the like. For example, such architecture may include an industry standard architecture (ISA) bus, micro channel architecture (MCA) bus, enhanced ISA (EISA) bus, video electronics standards association (VESA) local bus, and peripheral component interconnect (PCI) bus, which can be implemented as a Mezzanine bus manufactured to the IEEE P1386.1 standard, and the like.

Processing subsystem 1010 controls the operation of computer system 1000 and may comprise one or more processors, application specific integrated circuits (ASICs), or field programmable gate arrays (FPGAs). The processors may include single core or multicore processors. The processing resources of computer system 1000 can be organized into one or more processing units 1080, 1080, etc. A processing unit may include one or more processors, one or more cores from the same or different processors, a combination of cores and processors, or other combinations of cores and processors. In some aspects, processing subsystem 1010 can include one or more special purpose co-processors, such as graphics processors, digital signal processors (DSPs), or the like. In some aspects, some or all of the processing units of processing subsystem 1010 can be implemented using customized circuits, such as application specific integrated circuits (ASICs), or field programmable gate arrays (FPGAs).

In some aspects, the processing units in processing subsystem 1010 can execute instructions stored in system memory 1025 or on computer readable storage media 1055. In various aspects, the processing units can execute a variety of programs or code instructions and can maintain multiple concurrently executing programs or processes. At any given time, some, or all of the program code to be executed can be resident in system memory 1025 and/or on computer-readable storage media 1055 including potentially on one or more storage devices. Through suitable programming, processing subsystem 1010 can provide various functionalities described above. In instances where computer system 1000 is executing one or more virtual machines, one or more processing units may be allocated to each virtual machine.

In certain aspects, a processing acceleration unit 1015 may optionally be provided for performing customized processing or for off-loading some of the processing performed by processing subsystem 1010 to accelerate the overall processing performed by computer system 1000.

I/O subsystem 1020 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices, such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices, such as the Google Glass® blink detector that detects eye activity (e.g., "blinking" while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices, such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices, such as computed tomography, magnetic resonance imaging, position emission tomography, and medical ultrasonography devices. User interface input devices may also include, for example, audio input devices, such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays, such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics, and audio/video information, such as monitors, printers, speakers, headphones, automotive navigation systems, plotters, voice output devices, and modems.

Storage subsystem 1045 provides a repository or data store for storing information and data that is used by computer system 1000. Storage subsystem 1045 provides a tangible non-transitory computer-readable storage medium for storing the basic programming and data constructs that provide the functionality of some aspects. Storage subsystem 1045 may store software (e.g., programs, code modules, instructions) that when executed by processing subsystem 1010 provides the functionality described above. The software may be executed by one or more processing units of processing subsystem 1010. Storage subsystem 1045 may also provide a repository for storing data used in accordance with the teachings of this disclosure.

Storage subsystem 1045 may include one or more non-transitory memory devices, including volatile and non-volatile memory devices. As shown in FIG. 10, storage subsystem 1045 includes a system memory 1025 and a computer-readable storage media 1055. System memory 1025 may include a number of memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1010. In some implementations, system memory 1025 may include multiple different types of memory, such as static random-access memory (SRAM), dynamic random-access memory (DRAM), and the like.

By way of example, and not limitation, as depicted in FIG. 10, system memory 1025 may load application programs 1030 that are being executed, which may include various applications, such as Web browsers, mid-tier applications, relational database management systems (RDBMS), etc., program data 1035, and an operating system 1040. By way of example, operating system 1040 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, Palm® OS operating systems, and others.

Computer-readable storage media 1055 may store programming and data constructs that provide the functionality of some aspects. Computer-readable media 1055 may provide storage of computer-readable instructions, data structures, program modules, and other data for computer system 1000. Software (programs, code modules, instructions) that, when executed by processing subsystem 1010 provides the functionality described above, may be stored in storage subsystem 1045. By way of example, computer-readable storage media 1055 may include non-volatile memory, such as a hard disk drive, a magnetic disk drive, an optical disk drive, such as a CD ROM, digital video disc (DVD), a Blu-Ray® disk, or other optical media. Computer-readable storage media 1055 may include, but is not limited to, Zip® drives, flash memory cards, universal serial bus (USB) flash drives, secure digital (SD) cards, DVD disks, digital video tape, and the like. Computer-readable storage media 1055 may also include, solid-state drives (SSD) based on non-volatile memory, such as flash-memory based SSDs, enterprise flash drives, solid state ROM, and the like, SSDs based on volatile memory, such as solid-state RAM, dynamic RAM, static RAM, dynamic random access memory (DRAM)-based SSDs, magneto resistive RAM (MRAM) SSDs, and hybrid SSDs that use a combination of DRAM and flash memory based SSDs.

In certain aspects, storage subsystem 1045 may also include a computer-readable storage media reader 1050 that can further be connected to computer-readable storage media 1055. The computer-readable storage media reader 1050 may receive and be configured to read data from a memory device, such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program, such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1060 provides an interface to other computer systems and networks. Communications subsystem 1060 serves as an interface for receiving data from and transmitting data to other systems from computer system 1000. For example, communications subsystem 1060 may enable computer system 1000 to establish a communication channel to one or more client devices via the Internet for receiving and sending information from and to the client devices. For example, the communication subsystem may be used to transmit a response to a user regarding the inquiry for a Chatbot.

Communication subsystem 1060 may support both wired and/or wireless communication protocols. For example, in certain aspects, communications subsystem 1060 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects, communications subsystem 1060 can provide wired network connectivity (e.g., Ethernet) in addition to or instead of a wireless interface.

Communication subsystem 1060 can receive and transmit data in various forms. For example, in some aspects, in addition to other forms, communications subsystem 1060 may receive input communications in the form of data feeds 1065 such as structured and/or unstructured data feeds, event streams 1070, event updates 1075, and the like. For example, communications subsystem 1060 may be configured to receive (or send) data feeds 1065 in real-time from users of social media networks and/or other communication services, such as Twitter® feeds, Facebook® updates, web feeds, such as Rich Site Summary (RSS) feeds, and/or real-time updates from one or more third party information sources.

In certain aspects, communications subsystem 1060 may be configured to receive data in the form of continuous data streams, which may include event streams 1070 of real-time events and/or event updates 1075, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1060 may also be configured to communicate data from computer system 1000 to other computer systems or networks. The data may be communicated in various forms, such as structured and/or unstructured data feeds 1065, event streams 1070, event updates 1075, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in art can appreciate other ways and/or methods to implement the various aspects.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
receiving multiple requests from multiple source entities of a plurality of source entities via one or more connector modules, wherein:
a request of the multiple requests is directed to a particular digital record repository of one or more digital record repositories,
each connector module is dedicated to the particular digital record repository of the one or more digital record repositories,
the request of the multiple requests is generated by a source entity of the multiple source entities based on a first schema of a set of schemas,
a schema of the set of schemas defines a structured representation of one or more data entities, relationships among the data entities, and one or more attributes of the data entities that comprise field names and data types, and
each schema of the set of schemas are registered with a connector module of one or more connector modules corresponding to the particular digital record repository or the source entity of the plurality of source entities;
for each of the multiple requests:
validating, via the connector module of one or more connector modules, the request based on the first schema of the set of schemas associated with the source entity of the multiple source entities;
transforming the request via the connector module of one or more connector modules by utilizing a second schema of the set of schemas associated with the particular digital record repository of the one or more digital record repositories;
transmitting the transformed request to the particular digital record repository of the one or more digital record repositories;
monitoring, via the connector module of one or more connector modules, the particular digital record repository of the one or more digital record repositories at predefined intervals of time for a response associated with the transmitted request;
detecting, based on the monitoring, the response from the particular digital record repository of the one or more digital record repositories;
processing the response via the connector module of one or more connector modules by triggering one or more operations of a set of operations associated with the response; and
transmitting, via the connector module of the one or more connector modules, the processed response to the source entity.

2. The computer-implemented method of claim 1, wherein the request of the multiple requests comprises a backfill request that corresponds to accessing a part or all of missing digital records or an on-demand retrieval request that corresponds to accessing a set of digital records associated with a specific time period, and wherein the computer-implemented method further comprises:
emitting a first event indicating that the generated response is detected, including metadata of an operation of the one or more operations that corresponds to an export job, wherein the metadata comprises an operation identifier and a location of the generated response in the particular DRR of the one or more digital record repositories;
initiating a copy operation that copies the generated response from a file storage of the particular DRR of the one or more digital record repositories to an object storage of the connector module of the one or more connector modules based on the metadata of the operation;
monitoring the copy operation;
determining that the copy operation is successfully completed based on the monitoring; and
triggering a second event that corresponds to completion of the copy operation; and
emitting, via a system stream associated with the connector module of the one or more connector modules, a third event that corresponds to completion of the export job based on the triggering of the second event.

3. The computer-implemented method of claim 2, further comprising:
determining that the copy operation is unsuccessful in response to the monitoring;enerating, based on the determination, a second event indicating an unsuccessful copy operation; and
abandoning the copy operation.

4. The computer-implemented method of claim 2, further comprising:
generating, based on the third event, a notification to the source entity of the multiple source entities via the system stream associated with the connector module of the one or more connector modules indicating an availability of the generated response in the object storage corresponding to the backfill request or on-demand retrieval request.

5. The computer-implemented method of claim 1, wherein the request of the multiple requests comprises a write-back request that corresponds to an update to one or more digital records associated with the particular DRR of the one or more digital record repositories, and wherein the computer-implemented method further comprises:
receiving, via an event stream associated with the connector module of the one or more connector modules, the generated response from the particular DRR of the one or more digital record repositories associated with the write-back request, wherein the generated response indicates a successful update, a partial success with one or more validation errors, or a failure due to constraints;
validating the response using the second schema of the set of schemas; and
transmitting, via the event stream of the connector module of the one or more connector modules, the response to the source entity.

6. The computer-implemented method of claim 1, further comprising:
storing a status of each of the multiple requests and an associated set of jobs to a job registry of the connector module of the one or more connector modules that are configured to sequentially execute multiple requests from the multiple source entities.

7. The computer-implemented method of claim 1, further comprising: determining that two or more requests of the multiple requests from two or more source entities of the multiple source entities correspond to a same generated response; and
broadcasting the same generated response to the two or more source entities of the multiple source entities by leveraging a fan-out mechanism.

8. The computer-implemented method of claim 1, wherein the transformation includes: formatting the request of the multiple requests based on the structured representation of the second schema, converting the field names from the first schema of the set of schemas to the corresponding field names in the second schema of the set of schemas; and
mapping the relationships between the data entities of the source entity of the multiple source entities and the particular digital record repository of the one or more digital record repositories.

9. A system comprising:
one or more processors;
one or more non-transitory computer-readable media storing instructions, which, when executed by the system, cause the system to perform a set of operations comprising:
receiving multiple requests from multiple source entities of a plurality of source entities via one or more connector modules, wherein:
a request of the multiple requests is directed to a particular digital record repository of one or more digital record repositories,
each connector module is dedicated to the particular digital record repository of the one or more digital record repositories,
the request of the multiple requests is generated by a source entity of the multiple source entities based on a first schema of a set of schemas,
a schema of the set of schemas defines a structured representation of one or more data entities, relationships among the data entities, and one or more attributes of the data entities that comprise field names and data types, and
each schema of the set of schemas are registered with a connector module of one or more connector modules corresponding to the particular digital record repository or the source entity of the plurality of source entities; for each of the multiple requests:
validating, via the connector module of one or more connector modules, the request based on the first schema of the set of schemas associated with the source entity of the multiple source entities;
transforming the request via the connector module of one or more connector modules by utilizing a second schema of the set of schemas associated with the particular digital record repository of the one or more digital record repositories; transmitting the transformed request to the particular digital record repository of the one or more digital record repositories;
monitoring, via the connector module of one or more connector modules, the particular digital record repository of the one or more digital record repositories at predefined intervals of time for a response associated with the transmitted request;
detecting, based on the monitoring, the response from the particular digital record repository of the one or more digital record repositories;
processing the response via the connector module of one or more connector modules by triggering one or more operations of a set of operations associated with the response; and
transmitting, via the connector module of the one or more connector modules, the processed response to the source entity.

10. The system of claim 9, wherein the request of the multiple requests comprises a backfill request that corresponds to accessing a part or all of missing digital records or an on-demand retrieval request that corresponds to accessing a set of digital records associated with a specific time period, and wherein the set of operations further includes:
emitting a first event indicating that the generated response is detected, including metadata of an operation of the one or more operations that corresponds to an export job, wherein the metadata comprises an operation identifier and a location of the generated response in the particular DRR of the one or more digital record repositories;
initiating a copy operation that copies the generated response from a file storage of the particular DRR of the one or more digital record repositories to an object storage of the connector module of the one or more connector modules based on the metadata of the operation;
monitoring the copy operation;
determining that the copy operation is successfully completed based on the monitoring; and
triggering a second event that corresponds to completion of the copy operation; and
emitting, via a system stream associated with the connector module of the one or more connector modules, a third event that corresponds to completion of the export job based on the triggering of the second event.

11. The system of claim 10, wherein the set of operations further includes:
determining that the copy operation is unsuccessful in response to the monitoring;
generating, based on the determination, a second event indicating an unsuccessful copy operation; and
abandoning the copy operation.

12. The system of claim 10, wherein the set of operations further includes:
generating, based on the third event, a notification to the source entity of the multiple source entities via the system stream associated with the connector module of the one or more connector modules indicating an availability of the generated response in the object storage corresponding to the backfill request or on-demand retrieval request.

13. A computer-program product tangibly embodied in a non-transitory machine-readable storage medium, including instructions configured to cause one or more data processors to perform part a set of operations comprising:
receiving multiple requests from multiple source entities of a plurality of source entities via one or more connector modules, wherein:
a request of the multiple requests is directed to a particular digital record repository of one or more digital record repositories,
each connector module is dedicated to the particular digital record repository of the one or more digital record repositories,
the request of the multiple requests is generated by a source entity of the multiple source entities based on a first schema of a set of schemas,
a schema of the set of schemas defines a structured representation of one or more data entities, relationships among the data entities, and one or more attributes of the data entities that comprise field names and data types, and
each schema of the set of schemas are registered with a connector module of one or more connector modules corresponding to the particular digital record repository or the source entity of the plurality of source entities; for each of the multiple requests:
validating, via the connector module of one or more connector modules, the request based on the first schema of the set of schemas associated with the source entity of the multiple source entities;
transforming the request via the connector module of one or more connector modules by utilizing a second schema of the set of schemas associated with the particular digital record repository of the one or more digital record repositories;
transmitting the transformed request to the particular digital record repository of the one or more digital record repositories;
monitoring, via the connector module of one or more connector modules, the particular digital record repository of the one or more digital record repositories at predefined intervals of time for a response associated with the transmitted request;
detecting, based on the monitoring, the response from the particular digital record repository of the one or more digital record repositories;
processing the response via the connector module of one or more connector modules by triggering one or more operations of a set of operations associated with the response; and
transmitting, via the connector module of the one or more connector modules, the processed response to the source entity.

14. The computer-program product of claim 13, wherein the request of the multiple requests comprises a backfill request that corresponds to accessing a part or all of missing digitalrecords or an on-demand retrieval request that corresponds to accessing a set of digital records associated with a specific time period, and wherein the set of operations further comprises:
emitting a first event indicating that the generated response is detected, including metadata of an operation of the one or more operations that corresponds to an export job, wherein the metadata comprises an operation identifier and a location of the generated response in the particular DRR of the one or more digital record repositories;
initiating a copy operation that copies the generated response from a file storage of the particular DRR of the one or more digital record repositories to an object storage of the connector module of the one or more connector modules based on the metadata of the operation;
monitoring the copy operation;
determining that the copy operation is successfully completed based on the monitoring; and
triggering a second event that corresponds to completion of the copy operation; and
emitting, via a system stream associated with the connector module of the one or more connector modules, a third event that corresponds to completion of the export job based on the triggering of the second event.

15. The computer-program product of claim 14, wherein the set of operations further comprises:
determining that the copy operation is unsuccessful in response to the monitoring;
generating, based on the determination, a second event indicating an unsuccessful copy operation; and
abandoning the copy operation.

16. The computer-program product of claim 14, wherein the set of operations further comprises:
generating, based on the third event, a notification to the source entity of the multiple source entities via the system stream associated with the connector module of the one or more connector modules indicating an availability of the generated response in the object storage corresponding to the backfill request or on-demand retrieval request.

17. The computer-program product of claim 13, wherein the request of the multiple requests comprises a write-back request that corresponds to an update to one or more digital records associated with the particular DRR of the one or more digital record repositories, and wherein the wherein the set of operations further comprises:
receiving, via an event stream associated with the connector module of the one or more connector modules, the generated response from the particular DRR of the one or more digital record repositories associated with the write-back request, wherein the generated response indicates a successful update, a partial success with one or more validation errors, or a failure due to constraints;
validating the response using the second schema of the set of schemas; and
transmitting, via the event stream of the connector module of the one or more connector modules, the response to the source entity....

18. The computer-program product of claim 13, wherein the set of operations further comprises:
storing a status of each of the multiple requests and an associated set of jobs to a job registry of the connector module of the one or more connector modules that are configured to sequentially execute multiple requests from the multiple source entities.

19. The computer-program product of claim 13, wherein the set of operations further comprises:
determining that two or more requests of the multiple requests from two or more source entities of the multiple source entities correspond to a same generated response; and
broadcasting the same generated response to the two or more source entities of the multiple source entities by leveraging a fan-out mechanism.

20. The computer-program product of claim 13, wherein the transformation includes:
formatting the request of the multiple requests based on the structured representation of the second schema, converting the field names from the first schema of the set of schemas to the corresponding field names in the second schema of the set of schemas; and
mapping the relationships between the data entities of the source entity of the multiple source entities and the particular digital record repository of the one or more digital record repositories.
